(19) United States
(12) Patent Application Publication
(10) Pub. No.: US 2026/0002523 A1
(43) Pub. Date: Jan. 1, 2026

(54) MOLDED MAT WITH INTEGRATED FLUID FLOW CHANNELS AND MANIFOLD SYSTEM FOR ENERGY TRANSFER

(71) Applicant: FlowLoopX, Redding, CA (US)

(72) Inventors: Barak Cilluffo, Redding, CA (US); Keith Lemmer, Bella Vista, CA (US); Theodore Thompson, Redding, CA (US); David Pudwill, Redding, CA (US)

(21) Appl. No.: 19/264,101

(22) Filed: Jul. 9, 2025

Related U.S. Application Data
(63) Continuation-in-part of application No. 18/778,768, filed on Jul. 19, 2024.
(60) Provisional application No. 63/528,215, filed on Jul. 21, 2023.

(51) Int. Cl. F03G 7/08; F03B 17/00; H02K 7/18

(52) U.S. Cl. CPC F03G 7/085; F03B 17/005; H02K 7/1823; F05B 2260/421

(57) ABSTRACT

The present disclosure pertains to a device for capturing and converting kinetic energy into electrical energy. The device comprises a unitary molded mat body that includes a first plurality of parallel primary fluid flow channels integrally formed within its structure, where adjacent channels share dividing walls. These channels are arranged in a uniform, repeating pattern across the width of the mat. A first edge manifold channel extends along one edge of the mat, while a second edge manifold channel extends along the opposite edge. Each of the primary fluid flow channels is in fluid communication with both edge manifold channels, which are configured to connect to a pressure storage system. This configuration ensures efficient energy transfer, with fluid flow facilitated by the interconnected manifold and primary channels. The device's unitary construction optimizes durability and performance in converting kinetic energy into electrical energy.

### CROSS REFERENCE TO RELATED APPLICATIONS

This application is a continuation-in-part of U.S. patent application Ser. No. 18/778,768, filed on Jul. 19, 2024, which claims the benefit and priority of U.S. Provisional Application Ser. No. 63/528,215, filed on Jul. 21, 2023, which are hereby incorporated herein in their entireties including all references and appendices cited therein.

### FIELD

The present disclosure relates to the field of energy conversion technologies. Specifically, but not by way of limitation, this disclosure pertains to devices, methods, and systems designed for capturing kinetic energy from external sources, such as moving vehicles, and converting this kinetic energy into electrical energy. The present disclosure encompasses multi-layered structures, fluid dynamics, and mechanical-to-electrical energy conversion mechanisms aimed at optimizing the efficiency and practicality of energy harvesting in various applications.

### SUMMARY

A vehicular energy capture mat comprises a unitary molded mat body having a substantially polygonal shape. The unitary molded mat body comprises a first plurality of parallel primary fluid flow channels integrally formed within the unitary molded mat body. Adjacent ones of the first plurality of parallel primary fluid flow channels share integral dividing walls within the unitary molded mat body. The first plurality of parallel primary fluid flow channels are arranged in a uniform repeating pattern across a width of the unitary molded mat body. A first edge manifold channel extends along a first edge of the unitary molded mat body, and a second edge manifold channel extends along a second edge of the unitary molded mat body opposite the first edge. Each of the first plurality of parallel primary fluid flow channels is in fluid communication with both the first edge manifold channel and the second edge manifold channel. The first edge manifold channel and the second edge manifold channel are configured to connect to a pressure storage system.

The vehicular energy capture mat further comprises a pressure storage system. The pressure storage system comprises a bladder. The bladder separates the tank into a fluid chamber and an air chamber. The air chamber is configured to be pre-charged to a predetermined pressure level.

The predetermined pressure level is set based on expected vehicle types. A lower pressure setting is used for passenger vehicles, and a higher pressure setting is used for commercial vehicles.

The vehicular energy capture mat further comprises a hydro turbine coupled to the pressure storage system. Stored pressurized fluid drives the hydro turbine, and the hydro turbine drives a generator to produce electricity.

The pressure storage system is configured to store fluid at high pressure from vehicle displacement. The pressure storage system is further configured to release stored pressure gradually or rapidly to the hydro turbine based on power demand. The fluid channels are formed directly within the molded body without separate hoses or tubes.

The molded body comprises a wear-resistant upper surface for vehicle tire contact, flexible regions surrounding the fluid channels, and weather-resistant materials rated for temperatures from 0° F. to 180° F.

The pressure storage system is built within the mat itself or positioned outside of and adjacent to the mat.

The vehicular energy capture mat is configured for installation in vehicle deceleration zones. The vehicle deceleration zones are selected from approaching stop signs, near pedestrian walkways, before traffic signals, on highway exit ramps, and on downward-sloped roadways.

The vehicular energy capture mat further comprises an inverter connected to a generator. Electrical connections are configured to direct generated power to at least one of an electrical meter, a battery bank, or an electrical grid.

A vehicular kinetic energy capture and conversion system comprises a molded mat having a plurality of parallel fluid channels configured to displace fluid when compressed by vehicle tires. The system further comprises a pressure storage system. The pressure storage system comprises a bladder that separates pressurized air from fluid. An air side is pre-charged to a baseline pressure, and a fluid side receives fluid from the mat channels. The system further comprises a manifold system. The manifold system comprises fluid collection channels along mat edges, fluid transfer lines connecting the mat to the pressure storage system, and fluid return pathways for system circulation. The system further comprises an energy conversion assembly. The energy conversion assembly comprises a hydro turbine driven by pressurized fluid from the storage system, a generator coupled to the hydro turbine, and an inverter connected to the generator output. The system further comprises a control system. The control system is configured to monitor pressure levels in the storage system, regulate fluid flow to the hydro turbine, and direct electrical output to at least one of a battery, meter, or grid. Or adjacent mat system (?)—if combining into a network)

The pressure storage system is configured to maintain different baseline pressures for distribution centers handling heavy trucks, retail locations with passenger vehicles, and mixed traffic areas with varying vehicle weights.

The manifold system comprises a primary fluid collection manifold on a first mat edge, a secondary fluid collection manifold on an opposite mat edge, and cross-connection channels between the manifolds for pressure balancing.

The system further comprises multiple mats arranged in series or parallel. Interconnecting fluid lines are provided between adjacent mats, and a common pressure storage system serves the multiple mats.

The control system is configured to release stored pressure during peak electricity demand periods, maintain minimum pressure levels for system operation, and optimize energy generation based on traffic patterns.

The energy conversion assembly is configured to operate with variable fluid pressure inputs, maintain consistent electrical output, and shut down safely during low pressure conditions.

The mat comprises reinforced rubber compounds resistant to repeated compression, molded channel walls configured for millions of compression cycles, and wear-resistant surfaces for vehicle tire contact. The system further comprises pressure sensors throughout the fluid pathways, fluid level monitors in the storage system, and temperature sensors for system monitoring.

The manifold system includes an integrated fluid filter, a sediment collection point, and a maintenance access port. The system is configured to capture energy from decelerating vehicles, store energy as pressurized fluid, and release stored energy during periods of high electrical demand.

### BRIEF DESCRIPTION OF THE DRAWINGS

FIG. 1 illustrates an example device of the present disclosure for converting kinetic energy into electrical energy.

FIG. 2 is an exploded view of the device, illustrating the various substrates that comprise the device.

FIG. 3 is a schematic diagram of a system that incorporates the device of FIG. 2.

FIG. 4 is a schematic view of another hose configuration and orientation.

FIG. 5 is a top plan view of two devices and arranged side by side.

FIG. 6 is a diagrammatic view of wheels of a vehicle interacting with the plates of a device of the present disclosure.

FIG. 7 is an alternate energy capture device that can be used with a device or system of the present disclosure.

FIG. 8 is a perspective view of an example vehicular energy capture mat of the present disclosure, with a close-up view showing fluid channels and walls.

FIG. 9 is a schematic view of the mat of FIG. 8 in combination with other system components.

FIG. 10 is a cross-sectional view taken about section 10-10 of FIG. 9.

FIG. 11 is schematic view of another example system.

FIG. 12 is a schematic view of yet another example system.

FIGS. 13A-13E individually illustrate example cross-sectional portions of a mat.

FIG. 14 is a schematic diagram of another arcuate shaped energy capturing system.

FIG. 15 is a representation of an example machine in the form of a computer system.

FIG. 16 illustrates a detailed sub-assembly view of energy conversion and fluid management components corresponding to the vehicular energy capture and pressure storage system of FIG. 12.

FIG. 17 illustrates a detailed view of fluid pathway interconnections, check valves, and manifold arrangements within the energy conversion and fluid management sub-assembly.

### DETAILED DESCRIPTION OF EXAMPLE EMBODIMENTS

### Overview

As noted above, the present disclosure pertains to devices, methods, and systems designed for capturing and converting kinetic energy into electrical energy. An example device is constructed with multiple layers to optimize its functionality. At the top of the device is a first substrate that serves as the initial contact layer. Beneath this lies a second substrate which is covered by the first substrate. This second substrate is composed of semi-rigid plates that are spaced apart from one another, allowing for flexibility and movement.

Positioned below the second substrate is a hose arranged in a serpentine configuration. This hose is filled with a fluid and is strategically placed directly underneath each of the plates. The serpentine arrangement of the hose ensures that as the plates are depressed, the fluid within the hose is sequentially pushed through the system. A third substrate is located beneath the hose, providing additional support and structure to the device.

A fourth substrate placed between the second substrate and the hose to add additional structural support. Additionally, one-way valves may be installed, which help to control the flow of fluid, ensuring that the fluid moves in a single direction and thereby optimizing the conversion of kinetic energy into electrical energy.

The system includes an energy converter such as an electric motor/generator. The converter is in closed-loop fluid communication with the hose and is configured to generate electrical energy as the hose is depressed by the plates. The interaction between the fluid and the converter is what facilitates the transformation of mechanical movement into electrical power.

The energy conversion assembly is configured to convert the pressurized fluid energy into electrical power using a variety of generator types. Depending on system requirements and installation conditions, the generator may be implemented as a rotary generator, an alternator, a linear generator, or a magnetohydrodynamic generator. The rotary generator and alternator configurations provide efficient and well-established solutions for converting mechanical energy into electrical power, while the linear generator may be utilized in applications where direct displacement energy conversion is beneficial. The magnetohydrodynamic generator may be implemented in specialized applications where conductive fluid-based energy transfer offers efficiency advantages. The energy conversion assembly is further configured to integrate with an inverter or power conditioning system, ensuring compatibility with grid connections, battery storage, or direct-use applications. The system may be adapted for standalone operation or configured as part of a hybrid renewable energy infrastructure, working in conjunction with solar panels, wind turbines, or other distributed energy resources.

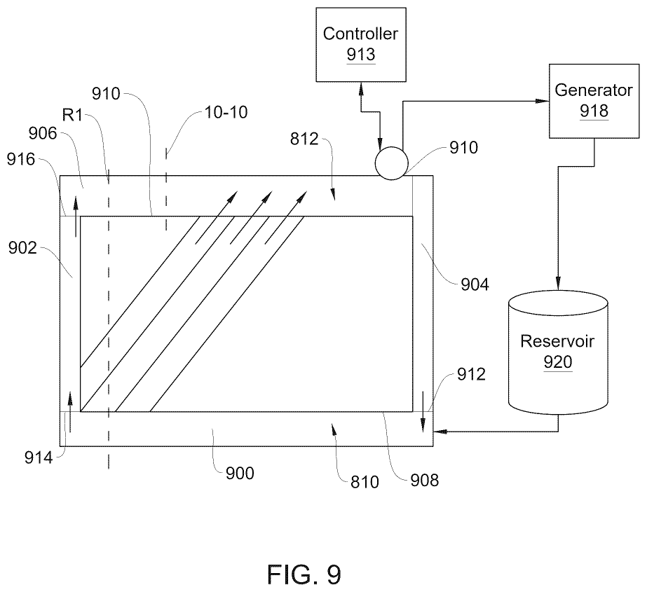

The system can also include an external storage bladder or reservoir (see FIG. 9 as one example) that serves as both a reservoir and pressure management system for the fluid. This storage bladder is fluidly coupled to the closed-loop system and can be positioned either adjacent to or integrated with the converter. The bladder is designed with reinforced walls capable of withstanding varied pressure conditions and includes internal baffles to minimize fluid turbulence. The storage bladder can be equipped with pressure relief valves to prevent over-pressurization and maintain system safety.

In operation, the storage bladder performs multiple functions within the system. When vehicle traffic is heavy and multiple plates are being depressed simultaneously, the storage bladder can accept (or safety discharge) excess fluid volume, preventing pressure spikes that could potentially damage the system components. Conversely, during periods of low traffic, the stored pressurized fluid can be released in a controlled manner through the converter, maintaining a consistent power output even when immediate kinetic energy input is reduced.

The bladder's capacity and pressure ratings are optimized based on expected traffic patterns and power generation requirements. Sensors within the bladder monitor fluid levels, pressure, and temperature, providing real-time data to the server 112. The server uses this information to dynamically control fluid flow between the bladder and converter, optimizing the system's overall efficiency. For example, during peak electricity demand periods, the server can release stored pressurized fluid from the bladder to supplement power generation, even if current traffic levels are low.

Multiple bladders can be interconnected in a network configuration, allowing for load balancing across several devices or locations. This network of storage bladders can be particularly useful in large installations, such as highway systems or extensive parking facilities, where energy generation and demand patterns may vary significantly across different areas or times of day. The interconnected bladders can share fluid capacity and pressure loads.

The method of utilizing a device as disclosed herein involves placing the device in locations where vehicles can drive over the device. As the wheels of a vehicle pass over the device, they sequentially depress the plates. This action causes the fluid in the hose to be sequentially propagated through the hose towards the converter. The continuous movement of fluid ensures a steady flow to the converter, enabling ongoing energy generation as vehicles continue to traverse the device. This method can be enhanced by adding features such as one-way valves before and after each plate to regulate the fluid flow.

This arrangement of the plates and the hose can create a sequential rocking effect or wave-like motion from one primary plate to another as they are sequentially depressed, further optimizing the energy conversion process.

The system designed for capturing and converting kinetic energy into electrical energy comprises multiple devices configured identically. Each device includes the aforementioned substrates, plates, and hose. These devices are supported by a device support frame, which elevates them above a subordinate surface. In the system, the hose of one device can extend through the support frame and connect to another converter that is co-located with the first device's converter, ensuring a seamless and efficient energy conversion process. The system may also feature angled ramps associated with the terminal edges of the devices and the support frame, facilitating the smooth passage of vehicles over the devices and enhancing the overall efficiency of energy capture and conversion.

### Example Embodiments

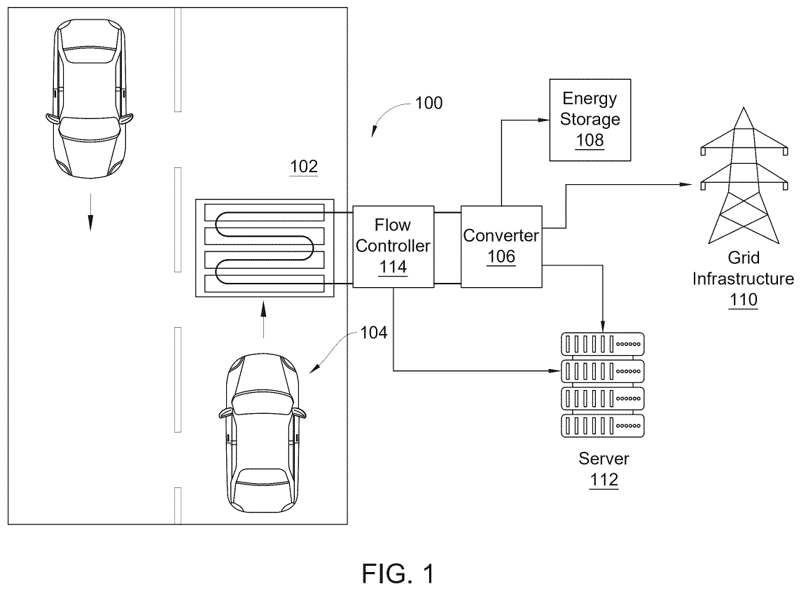

FIG. 1 illustrates an example device 100 of the present disclosure for converting kinetic energy into electrical energy. The device 100 is comprised of a series of substrates arranged in a layered configuration, as will be discussed in greater detail infra.

The device 100 for capturing and converting kinetic energy into electrical energy can be effectively utilized in various locations where there is consistent directional movement of vehicles or other sources of kinetic energy. One prime location for such a device is roadways and highways. By embedding the device in the surface of roads and highways, the constant traffic flow can generate substantial amounts of kinetic energy. This energy can then be converted into electrical power to support roadway lighting, traffic signals, and other infrastructure needs, thereby reducing dependency on conventional power sources.

Another ideal location for this device is in parking lots, especially in commercial areas, shopping malls, and office complexes. The movement of vehicles entering and exiting the parking area provides a continuous source of kinetic energy. The generated electrical energy can be used to power security systems, lighting, and electric vehicle charging stations, enhancing the sustainability of these facilities.

Toll plazas and weigh stations also offer significant potential for this technology. These locations experience a high volume of vehicle stop-and-go movement, making them perfect candidates for the installation of the device. The energy captured from the frequent starts and stops of vehicles can be utilized to power the operations of the toll plaza or weigh station, including electronic toll collection systems, lighting, and communication equipment.

Additionally, the device can be used in urban settings, such as busy intersections and pedestrian crossings, where both vehicular and pedestrian traffic can be harnessed to generate energy. This energy can be fed back into the grid or used locally to power streetlights, traffic signals, and public charging stations. By integrating this device into various high-traffic areas, cities can improve their energy efficiency and sustainability.

In industrial and commercial transportation hubs, such as airports, seaports, and distribution centers, the device can capture energy from the constant movement of vehicles, luggage carts, and other equipment. This energy can be converted to support the electrical needs of these large facilities, contributing to overall energy savings and operational efficiency.

In railway applications, the device can be strategically deployed near rail crossings and station approaches to capture the substantial kinetic energy from decelerating trains. When installed in these locations, the device serves a dual purpose: energy harvesting and assisted deceleration. The plates and underlying hydraulic system can be reinforced and scaled to handle the significantly higher loads presented by rail traffic, with plates spanning the width of the tracks and integrated into the existing rail infrastructure.

For railway installations, the device incorporates specialized adaptations to handle the unique characteristics of rail transport. The plates are engineered to maintain proper track geometry and rail spacing while enabling vertical displacement under load. The hydraulic system is designed with increased capacity to handle the substantial energy input from decelerating trains, which can be orders of magnitude greater than that of vehicular traffic. This captured energy can then power station operations, signaling systems, and even feed back into the railway's electrical grid for use by electric locomotives.

In airport applications, the device can be integrated into taxiways and runway approaches to capture kinetic energy from aircraft during taxi operations and landing deceleration. The system's plates are specially engineered to meet aviation surface requirements and can withstand the extreme loads and unique stress patterns generated by aircraft wheels. When installed in the landing zone of runways, the device can assist in aircraft deceleration while simultaneously capturing energy that would otherwise be dissipated as heat through conventional braking systems.

For airport installations, the device features additional safety and monitoring systems specific to aviation requirements. The plates are designed to maintain proper runway friction coefficients and surface characteristics as specified by aviation authorities. The hydraulic system incorporates enhanced pressure management capabilities to handle the intense, short-duration energy inputs characteristic of aircraft operations. This captured energy can be particularly valuable for airports, helping to power runway lighting systems, terminal operations, and other high-energy demand facilities within the airport complex.

Both rail and airport implementations utilize enhanced versions of the storage tank system, capable of managing the larger energy inputs characteristic of these applications. These specialized storage systems can include multiple interconnected tanks with rapid pressure equalization capabilities, allowing them to effectively capture and store the significant energy inputs from trains or aircraft while maintaining safe system pressures. The stored energy can then be released at controlled rates to provide consistent power output despite the intermittent nature of rail and aircraft traffic.

The device 100 can be placed onto various substrates 102, such as roadways, parking lots, and other surfaces with frequent vehicular traffic. When a vehicle 104 drives over the device 100, the ground engaging members (such as wheels) of the vehicle 104 contact the device 100. This interaction transfers kinetic energy to the device 100, which is then converted into electrical energy by the device 100. This conversion process harnesses the otherwise wasted kinetic energy from moving vehicles, providing a valuable source of renewable energy that can be used to power various infrastructure elements such as streetlights, traffic signals, and public charging stations.

A flow controller 114 can be positioned before the converter 106. The flow controller 114 plays a role in regulating the pressure and flow rate of the fluid as the fluid moves towards the converter 106. This ensures the converter 106 operates within optimal parameters, maximizing the efficiency of the energy conversion process and preventing damage to the device 100. While a single converter is shown, in some embodiments a plurality of converters can be coupled with the hose. An additional embodiment includes a configuration where multiple hoses, whether running perpendicular or parallel to the plates, feed into a main line. This main line then directs the fluid to a single or multiple generators. Each hose is equipped with a valve to regulate the ingress and egress of fluid into the main line.

The flow controller 114 can be controlled by a server 112, which is integrated into the overall smart control system of the device. The server 112 monitors real-time data from various sensors placed throughout the system, including those measuring fluid flow, pressure, and temperature. Based on this data, the server 112 can dynamically adjust the settings of the flow controller 114 to maintain consistent and optimal fluid conditions.

By regulating the pressure and flow rate with the flow controller 114, the system can prevent issues such as overpressure, which could damage components or reduce efficiency. This regulation ensures a steady and controlled flow of fluid to the converter 106, enhancing the overall performance and reliability of the device.

The integration of the flow controller 114 with the server 112 allows for advanced features such as predictive maintenance and automated adjustments based on environmental conditions or changes in vehicle traffic patterns. This smart control capability not only improves the efficiency of the kinetic energy conversion process but also extends the lifespan of the device by maintaining optimal operating conditions at all times.

The system incorporates real-time sensing and adjustment capabilities to optimize energy capture based on vehicle characteristics. Load cells integrated beneath the plates continuously monitor the weight distribution of passing vehicles, while speed sensors measure approach velocity. This data is processed by the server 112 in real-time to dynamically adjust system parameters, ensuring optimal energy capture while maintaining safe operation conditions for varying vehicle types and speeds.

The server 112 can be programmed with preset configurations for common vehicle classes, from passenger cars to heavy commercial trucks, allowing for rapid system adjustment as different vehicle types approach. These preset configurations modify multiple system parameters, including fluid pressure thresholds, plate depression rates, and storage tank operation. For example, when sensors detect an approaching semi-truck, the system automatically adjusts to handle the higher weight loads and different axle configurations, ensuring efficient energy capture without risking system overload.

The dynamic compensation system also accounts for vehicle speed, adjusting the timing and sequence of plate activation to optimize energy capture. At higher approach speeds, the system can preemptively adjust fluid pressures and flow rates to better handle the rapid energy input. Conversely, for slower-moving vehicles, the system modifies its parameters to maximize energy capture from the extended contact time. This speed-based compensation ensures efficient energy harvesting across a wide range of traffic conditions.

The system maintains a continuous learning algorithm that analyzes patterns in vehicle weight, speed, and energy capture efficiency. This data is used to refine the preset configurations and improve real-time adjustments. For instance, if the system consistently encounters a particular type of heavy vehicle at specific times, it can preemptively prepare for these events, optimizing both energy capture and system longevity.

Environmental conditions are also factored into the compensation calculations. Temperature sensors monitor both ambient and system temperatures, allowing the server to adjust fluid dynamics parameters accordingly. During cold weather, the system may modify its pressure thresholds and flow rates to account for changes in fluid viscosity, while in hot weather, it can adjust cooling system operation to maintain optimal operating temperatures.

In some instances, the device 100 includes a converter 106, such as an electric generator or a similar device, that converts the kinetic energy from vehicular motion into electrical energy. While discussed in greater detail below, the device includes hydraulic elements (plates) that are compressed by the relative motion of the vehicle, causing fluid transfer that can be captured by the converter and transformed into electrical energy. Thus, the weight and forward motion of the vehicle causes hydraulic displacement of a fluid, which operates the converter 106 to produce electrical energy.

The converter 106 can be coupled to energy storage 108, such as a battery or a load for immediate local use, providing power to streetlights, traffic signals, and other infrastructure elements directly. Alternatively, the converter 106 can be connected, either directly or indirectly, to the grid infrastructure 110. This connection allows the device 100 to feed captured energy back into the grid infrastructure 110, particularly during peak hours when the demand and cost for electricity are high, resulting in compensation at premium rates.

Furthermore, the server 112 can control the distribution of the captured energy. The server 112 can determine whether to store the energy in the battery 108 or feed the energy into the grid infrastructure 110 based on real-time monitoring of electricity prices and demand. During times of high electricity demand and cost, the server can direct the stored energy from the battery 108 back into the grid infrastructure 110, maximizing economic benefits. This intelligent control system ensures efficient energy management, optimizing both local usage and grid contributions.

In some embodiments, the device can electrically couple with and direct the generated electrical energy into an electrical meter of a local business or government agency. By integrating the device into high-traffic areas, such as roadways or parking lots, the kinetic energy captured from moving vehicles can be efficiently converted into electrical energy and then fed directly into the electrical infrastructure of nearby buildings. This approach not only provides a sustainable and renewable energy source for the local infrastructure but also reduces dependency on the main power grid, potentially lowering electricity costs for businesses or government agencies. Additionally, this configuration can facilitate real-time monitoring and management of energy consumption, further optimizing energy usage and efficiency.

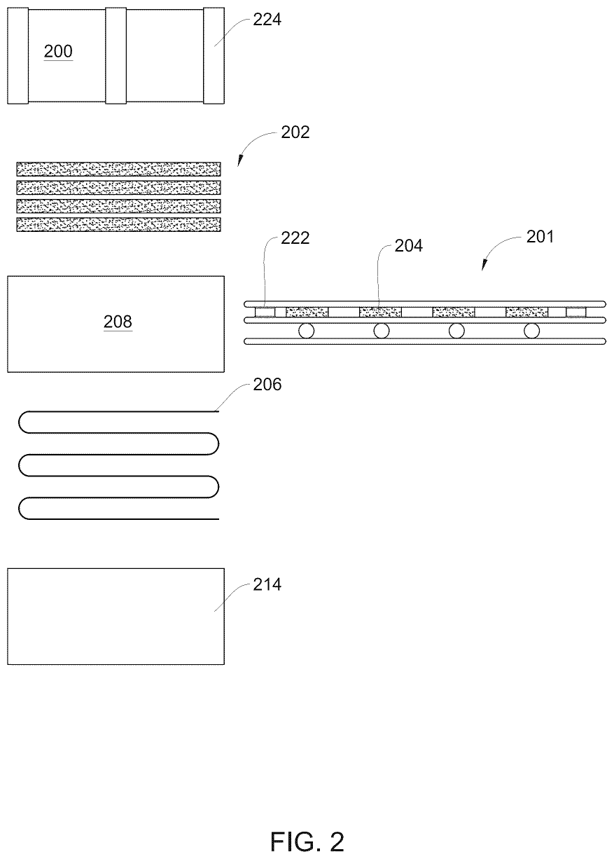

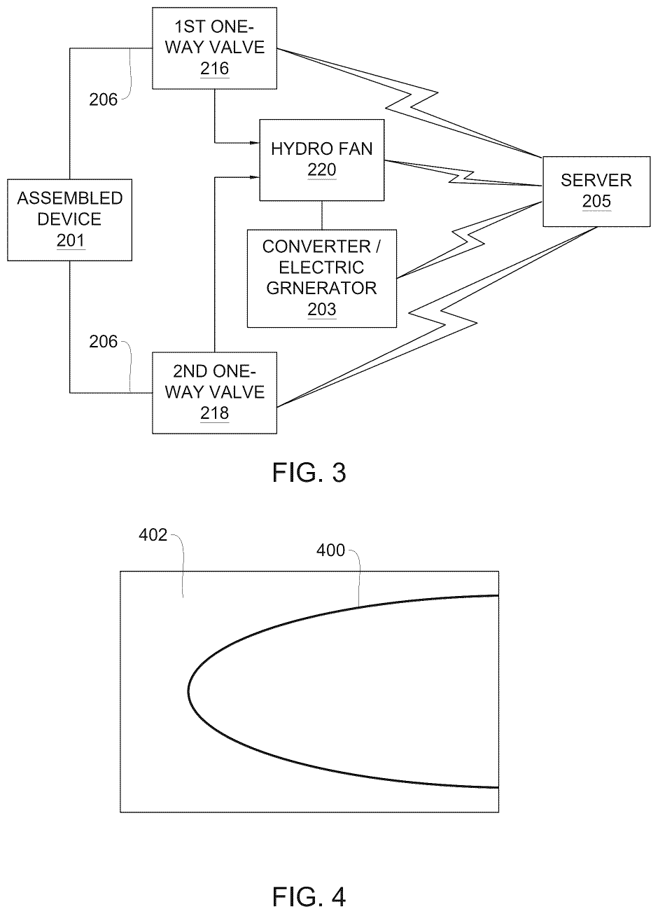

FIG. 2 is an exploded view of the substrates used to create a device. FIG. 3 is a schematic diagram of a system that incorporates the assembled device 201 of FIG, 2. The following description will reference both FIGS. 2 and 3 collectively. The first substrate 200 serves as the top layer of the device and is designed to provide a durable and stable surface for contact with external forces such as vehicle wheels. This first substrate 200 could be made from high-strength materials like reinforced rubber or composite polymers to withstand the repeated stress and impact from vehicular traffic.

Directly beneath the first substrate is the second substrate 202 which is covered by the first substrate. The second substrate 202 includes a series of semi-rigid plates 204 strategically spaced apart from one another. These plates 204 are semi-rigid to allow for slight movement and flexion as external forces are applied. The plates 204 could be constructed from materials such as high-density polyethylene (HDPE) or a resilient metal alloy like aluminum to balance flexibility and strength. This design ensures that when a vehicle wheel or another source of kinetic energy makes contact, the plates 204 can depress slightly, transferring the kinetic energy to the underlying structures, such as a hose.

Each of the semi-rigid plates 204 is crucial for the device's functionality. The spacing between adjacent plates 204 allows for the necessary movement and prevents the plates from interfering with each other's motion. This arrangement ensures that the kinetic energy is effectively captured and transmitted to the next layer. Positioned directly beneath the second substrate 202 and its semi-rigid plates 204 is a hose 206 arranged in a serpentine configuration. The hose 206 is filled with fluid and aligned directly under each plate 204, ensuring that as each plate is depressed, the hose 206 creates a localized increase in pressure within the hose 206. The hose 206 could be made from durable, flexible materials such as reinforced rubber or silicone to handle the pressure changes and maintain integrity over prolonged use. Additionally, thermoplastic elastomers (TPE) can be used, offering a balance of flexibility, strength, and chemical resistance.

To ensure the system operates efficiently in high or low temperatures, fluid additives can be incorporated into the fluid within the hose. These additives would modify the fluid properties to prevent freezing in low temperatures and reduce thermal expansion in high temperatures, thereby maintaining optimal fluid dynamics and system performance under varying environmental conditions. Sensors can be placed throughout the fluid loop of the hose and sense the temperature of the fluid with the hose at various locations.

The system's working fluid can be either a liquid or a gas, each offering distinct advantages for energy transfer and system efficiency. When using a liquid medium, common choices include hydraulic oils, water-based solutions, or specialized synthetic fluids designed for optimal energy transfer characteristics. In gas-based implementations, compressed air or other inert gases can serve as the working fluid, offering unique benefits such as natural compressibility and reduced system weight.

Gas-based systems leverage the compressibility of the working fluid as an additional energy storage mechanism. When the plates compress the gas-filled hoses, the gas temporarily stores energy through compression before releasing it to drive the converter. This characteristic can be particularly advantageous in applications where weight sensitivity is crucial, such as aerospace implementations, or in environments where liquid leakage could pose operational concerns.

To maximize energy capture efficiency, the working fluid can be enhanced with various friction-reducing additives. Graphene, when properly dispersed within the fluid, creates a nanoscale lubricating layer that significantly reduces friction between the fluid and the internal surfaces of the system. This reduction in friction allows for more efficient energy transfer from the plates to the converter, improving overall system performance. Similarly, ascorbic acid can be incorporated as an additive, particularly in water-based solutions, where it helps reduce surface tension and minimize energy losses due to fluid friction.

The selection of specific additives depends on the base fluid and intended application. For gas-based systems, dry lubricants like graphene can be suspended in the gas flow to reduce friction along the system walls. In liquid systems, both graphene and ascorbic acid can be used in combination with other conventional lubricating additives to create optimized fluid formulations. The concentration of these additives is carefully controlled to maintain proper fluid dynamics while maximizing their friction-reducing benefits.

These enhanced fluids can be further optimized through the addition of stability agents that prevent additive settling or separation, ensuring consistent performance over time. Temperature stabilizers may also be incorporated to maintain optimal fluid properties across a wide range of operating conditions, particularly important in outdoor installations subject to significant temperature variations. Fluid may also have bacteria growth inhibitors or other similar additives to ensure that environmental factors do not deleteriously effect performance.

The system's control algorithms can be programmed to account for the specific properties of the working fluid, whether gas or liquid, and its additive package. This allows for real-time adjustments to pressure thresholds, flow rates, and energy conversion parameters based on the known behavior of the selected fluid medium, ensuring optimal energy capture regardless of the specific fluid formulation in use.

As the vehicle contacts the plates, the transferred pressure forces the fluid to move in a controlled, one-way direction towards a converter (which is responsible for transforming the kinetic energy into electrical energy. After compression, the hose 206 can expand back to an original size due to the resilient nature of the material used to manufacture the hose 206. In some instances, springs or other resiliently biased members 222 can be placed between adjacent plates. These resilient members would push upwards on the first substrate 200, causing the plates of the second substrate to be elevated back to their original positions.

The exploded view in FIG. 2 also shows the third substrate 208 situated below the hose 206. The third substrate 208 provides structural support for the entire assembly, ensuring stability and durability. The third substrate 208 could be made from sturdy materials like steel or reinforced concrete to provide a strong foundation. Additionally, there is a fourth substrate 214 which can be placed between the second substrate 202 and the hose 206, adding an extra layer of support and helping to maintain the alignment and integrity of the components above. The fourth substrate 214 could be constructed from high-strength plastic or composite materials that offer support without adding excessive weight.

To ensure a robust and durable assembly, the layers can be joined using various manufacturing techniques. One effective method is sonic welding, which uses high-frequency ultrasonic acoustic vibrations to create solid-state welds between the materials. This technique is particularly useful for joining plastic components, ensuring a strong bond without the need for adhesives or additional fasteners. Other potential manufacturing methods include adhesive bonding, where specialized industrial adhesives create a strong and flexible bond between layers, and mechanical fastening, which might involve screws, bolts, or rivets to securely attach the different substrates and components. These manufacturing techniques contribute to the overall durability and longevity of the device, ensuring that it can withstand the stresses and demands of regular use in various environments. Regardless of the method used to join the substrates, an assembled device 201 is shown in FIG. 2.

In another embodiment, metal rails 224 can be installed on the sides and middle of the device to guide a snow plow over the device without causing damage. These rails would be strategically positioned to protect the plates and hoses from the impact and scraping of the snow plow. FIG. 2 depicts this embodiment, showing the placement of metal rails to safeguard the device during snow removal operations. These metal rails can be added to any embodiment.

To ensure efficient and controlled fluid flow, the device incorporates one-way valves positioned before and after the converter or electric generator 203. A first one-way valve 216 is located before the converter 106 to allow fluid to enter the converter/generator 203, and another, second one-way valve 218 is positioned after the converter 106 to enable the fluid to exit. These valves ensure that the fluid flows in only one direction across the converter/generator 203, preventing any backflow that could disrupt the energy conversion process. By maintaining a consistent and directed flow of fluid through the converter/generator 203, the one-way valves 216 and 218 optimize the efficiency of the kinetic-to-electrical energy transformation, ensuring that the system operates effectively and reliably. In some instances, one-way valves can be placed before and after each of the plates. In another example, a single one-way valve is positioned before the first plate and another one-way valve after the last plate. These valves ensure that the fluid flows only in the intended direction, preventing any potential backflow and enhancing the overall energy transfer efficiency.

In some instances, a hydro fan 220 is integrated in-line with the hose 206, allowing the fluid within the hose 206 to drive the hydro fan 220. As the fluid flows through the hose 206, the fluid impinges on the blades of the hydro fan 220, causing the hydro fan 220 to rotate. This rotational motion is then transferred to the converter 106, which in this configuration, is an electric generator. The rotation of the hydro fan 220 effectively turns the electric generator, converting the kinetic energy of the fluid flow into electrical energy. The use of a hydro fan 220 enhances the efficiency of the energy conversion process by maximizing the mechanical energy transferred from the fluid to the electric generator, thereby optimizing the overall performance of the device. This configuration ensures a steady and reliable production of electricity as the fluid continuously drives the hydro fan 220 within the hose 206 as vehicles pass over the device 201.

It will be understood that the fan blades of the hydro fan 220 can be configured to turn based on fluid flow in a single direction, however, in some instances, the hydro fan 220 has blades that allow the shaft connected to the converter to turn in two directions to generate electrical power. A server 205 can be equipped with a switch or similar mechanism to manage fluid flow from two different directions. This switch can be placed before the converter 106 to selectively direct fluid flow from either direction. By doing so, the server 205 can ensure optimal energy capture and conversion regardless of the direction of vehicle movement. The switch is controlled by the server 205, which monitors real-time data from sensors measuring fluid flow and pressure within hoses. Based on this data, the server dynamically adjusts the switch to accept fluid flow from the direction with the highest pressure or flow rate, thereby maximizing the efficiency of the energy conversion process. This ability to control fluid flow from multiple directions enhances the system's versatility and ensures consistent electrical power generation under varying traffic conditions.

The device's control and switching mechanisms can be implemented through mechanical or pneumatic systems in addition to or instead of electronic controls. In mechanical implementations, the flow control can be achieved through a series of mechanically linked valves and actuators that respond directly to physical inputs from the plates. These mechanical systems can include cam-operated valves, spring-loaded regulators, and mechanical sequencers that coordinate fluid flow based on the physical movement of system components. This approach provides robust operation without relying on electronic controls, particularly advantageous in environments where electronic systems may be vulnerable to interference or damage.

Pneumatic control systems offer another alternative, using compressed air logic circuits to manage fluid flow and system operation. These pneumatic controls can include pressure-activated switches, pneumatic timing circuits, and air-operated valves that respond to system conditions without electronic intervention. The pneumatic control systems can be particularly effective when the working fluid is a gas, as they can share the same compressed air supply used for control functions.

The device could be designed as a single pad made from rubber mold injection. This pad would integrate both the semi-rigid plates and the hose or fluid channels within the pad itself, providing a seamless and robust structure.

The device incorporates an advanced materials engineering approach in its pad construction, utilizing a strategic combination of dissimilar materials to optimize performance characteristics at specific locations. This composite structure combines materials with varying properties such as toughness, strength, and flexibility, each precisely positioned where its particular characteristics provide maximum benefit. For example, high-strength materials might be concentrated in areas of maximum stress, while more flexible materials are positioned where deformation is beneficial for energy capture.

The pad's material composition varies not only horizontally but also through its thickness, creating a gradient of mechanical properties. This might include a tough, wear-resistant upper layer for durability, a middle layer engineered for optimal energy transfer, and a bottom layer designed for structural support and integration with the substrate. These layers are permanently bonded during manufacturing to create a unified structure that maintains distinct property zones.

A key feature of the pad design is its modular connectivity feature, allowing multiple pads to be joined in sequence to create extended installations of various widths and lengths. The pad edges incorporate specialized connection interfaces that enable secure mechanical coupling while maintaining consistent energy transfer characteristics across the joints. These connections can include interlocking geometries, mechanical fasteners, or chemical bonding systems, depending on the specific installation requirements.

The manufacturing process accommodates variations in pad dimensions and thickness while maintaining consistent performance characteristics. Different sections of the pad assembly can be manufactured with varying thicknesses or densities to optimize performance for specific applications or loading conditions. This flexibility in manufacturing allows for customization of pad properties to match specific installation requirements while maintaining the core energy capture functionality.

The modular design extends to the internal fluid channels, with each pad section incorporating standardized fluid connection points that allow for seamless integration of multiple pad sections into a larger system. These connections maintain proper fluid dynamics across pad boundaries while allowing for easy installation and maintenance of extended pad arrays.

As noted above, in some embodiments, the hose can be oriented in a serpentine configuration. In other embodiments, the hose 400 is arranged in a parabolic configuration, as shown in FIG. 4 above or below a substrate 402. This parabolic configuration can be substituted for the serpentine configuration in certain devices, offering an alternative layout for the fluid flow path. Similar to the serpentine arrangement, the parabolic hose configuration can be connected to a converter and one-way valves and to ensure a consistent, unidirectional flow of fluid. This design maintains the efficiency of the energy conversion process by directing the fluid through the converter in a controlled manner, thereby optimizing the device's ability to capture and convert kinetic energy into electrical energy.

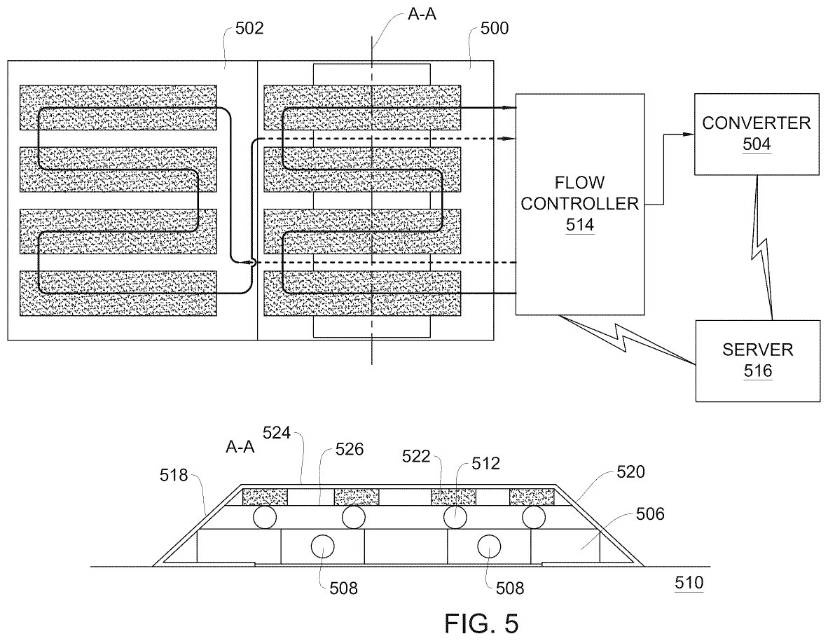

FIG. 5 is a top plan view of two devices 500 and 502 arranged side by side. In this configuration, device 500 captures energy from vehicles moving in one direction, while device 502 captures energy from vehicles moving in the opposite direction. To facilitate the use of a single converter 504, device 500 is mounted on a partially hollow device frame 506. This design allows the hose 508 of device 502 to pass underneath device 500 and connect to the converter 504. As best shown in section A-A, the device frame 506 can be constructed from a metal frame or grid that supports device 500 above a subordinate surface 510, such as a road. Proper orientation of the hose 508 of device 502 ensures that the fluid flow in hose 508 is unidirectional and consistent with the flow in hose 512 of device 500.

To address concerns of excess pressure that may arise from vehicles moving over both devices 500 and 502 simultaneously, a flow controller 514 can be optionally integrated into the system. The flow controller 514 is positioned before the converter 504 and is controlled by a server 516. The server 516 monitors real-time data from sensors measuring fluid flow and pressure within hoses 508 and 512. When both devices 500 and 502 experience simultaneous vehicle pressure, the server 516 dynamically adjusts the flow controller 514 to regulate the fluid pressure, preventing any potential overpressure conditions that could damage the converter 504 or reduce system efficiency.

As with other embodiments, one-way valves can be incorporated into the system to facilitate the direction of flow shown by the arrows in FIG. 5. It will be understood that each device 500 and 502 can be connected to a discrete converter rather than a single converter. These converters can be co-located on the same side of a roadway as one another.

In some embodiments, to accommodate the extra height of the device frame 506, a device, such as device 500 can include end cap ramps 518 and 520. The end cap ramp 518 provides an angled surface that a vehicle can drive upon in order to interact with plates, such as plate 522 of device 500. The end cap ramps 518 and 520 can also function to capture the terminal ends of the substrate layers used to create the device 500. For example, substrate layers 524 and 526 are covered and can be coupled with the end cap ramps 518 and 520.

### Devices and Systems in Use

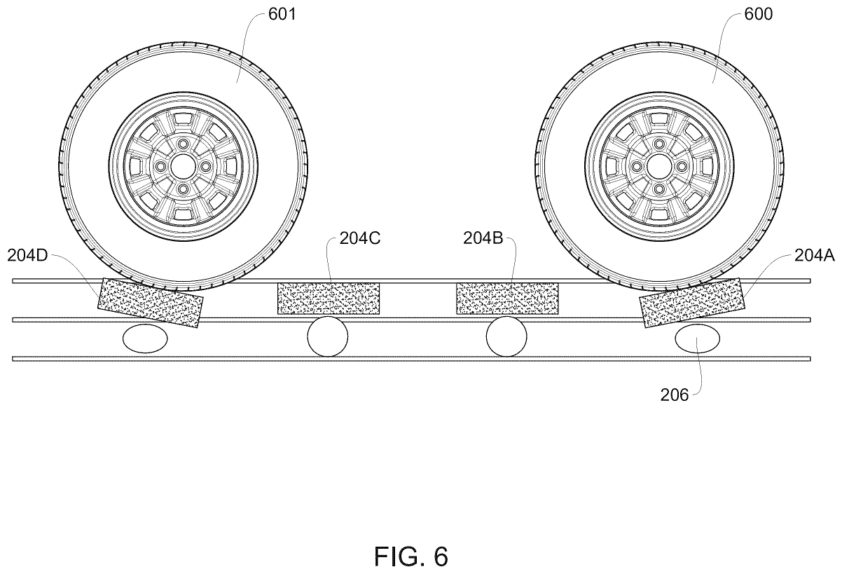

Referring now to FIGS. 1-6 collectively, as a vehicle moves over the device, the interaction between the wheels 600 and 601 and the sequentially arranged plates generates a one-way fluid flow through the system (see plates 204A-204D). Each plate 204 is strategically positioned over a fluid-filled hose 206 and is designed with a semi-rigid structure to facilitate movement. As the vehicle's wheels come into contact with each plate 204, the force of the impact depresses the hose 206 directly beneath the plate. For example, wheel 600 compresses plate 204A, and wheel 601 compresses plate 204B.

When the hose 206 is depressed, the fluid within the hose 206 is displaced, creating a localized increase in pressure at the point of contact. This pressure forces the fluid to move in one direction through the hose 206, maintaining a consistent and directed flow of fluid. As the vehicle continues to move, each subsequent plate 204 is sequentially depressed by the wheels, continuing the movement of the fluid. The fluid displacement from each plate 204A-204D combines to create a continuous and coordinated flow through the hose 206.

This one-way fluid flow ensures that the kinetic energy imparted by the vehicle is effectively transmitted along the length of the hose 206 towards the converter 210 (see FIG. 3). The converter 210, which can be an electric generator or other similar device, receives the fluid and uses its pressure and movement to generate electrical energy. The continuous and one-way nature of the fluid flow maximizes the efficiency of energy transfer, minimizing losses and ensuring a steady supply of kinetic energy to be converted into electrical power. This fluid dynamic system not only captures the energy from the vehicle's movement but also optimizes its conversion into useful electrical energy, which can be used locally or fed back into the grid during peak demand times for optimal economic benefits.

When a vehicle drives over the device, the interaction between the wheels and the sequentially arranged plates 204A-204D generates a unique “wave motion.” Each plate 204A-204D is strategically positioned over a fluid-filled hose 206 and designed with a semi-rigid structure to facilitate movement. As the vehicle's wheels come into contact with each plate, the force of the impact causes a plate to rock slightly. This rocking motion, combined with the pressure applied by the vehicle, depresses the hose 206 directly beneath the plate. For example, wheel 600 causes plate 204A to rock as it rolls onto plate 204A and wheel 601 causes plate 204D to rock as it rolls off of plate 204D.

The depression of the hose 206 displaces the fluid within the hose 206, creating a localized increase in pressure. As the vehicle progresses, the subsequent plates 204A-204D experience the same depressing actions. This sequential depression of the plates 204A-204D generates a fluid displacement that propagates through the hose 206 in a ripple or wave-like manner, similar to the effect observed when a wave travels across the surface of water.

This wave motion is not merely a series of independent actions but a continuous and coordinated flow of energy. The fluid in the hose 206 moves in a wave-like pattern, effectively transmitting the kinetic energy imparted by the vehicle's movement along the length of the hose 206. This continuous propagation of energy ensures a steady and efficient transfer of kinetic energy towards the converter.

The wave motion enhances the efficiency of the energy conversion process. By maintaining a consistent flow of fluid, the system minimizes energy losses and maximizes the amount of kinetic energy converted into electrical energy. This dynamic interaction between the plates 204A-204D and the hose 206 allows the device to capture energy from each wheel movement effectively. The resulting electrical energy can then be used locally to power infrastructure elements such as streetlights and traffic signals or be fed back into the grid, particularly during peak times when electricity demand and prices are high. This intelligent design and operation make the device an innovative solution for harnessing renewable energy from everyday vehicular motion, contributing to more sustainable and energy-efficient urban environments.

The dimensions of the device are carefully designed to optimize the interaction between the semi-rigid plates and the fluid-filled hose, ensuring efficient energy capture and conversion. The size and spacing of the plates within the device are tailored to match the average wheelbase of vehicles expected to drive over the device. This alignment maximizes the wave-like interaction and fluid flow, thereby enhancing the overall performance of the system.

Each semi-rigid plate 204 is strategically positioned to correspond with the typical distance between the front and rear wheels of a vehicle. The average wheelbase for most passenger vehicles ranges from approximately 2.5 meters to 3 meters (98 to 118 inches). To accommodate this, the plates are spaced apart accordingly, ensuring that as the front wheels of a vehicle depress the initial plates, the rear wheels will sequentially engage with the subsequent plates. This sequential engagement creates a continuous and coordinated wave motion in the fluid-filled hose 206, optimizing the displacement and energy transfer process.

In some embodiments, each plate is around four to twenty inches wide (lateral dimension), and in some instances, the dimensions are preferable between six and twelve inches, allowing for adequate surface area to capture the kinetic energy from the vehicle's wheels. The longitudinal dimension (length) can vary to enhance the wave type motion disclosed herein. The thickness of the plates is designed to be sufficient to provide the necessary rigidity while allowing for slight flexion. This balance ensures that the plates can effectively transfer the kinetic energy to the hose 206 without compromising durability.

The overall width of the device is designed to cover the span between the front and rear wheelbases of a vehicle, typically around 2.1 to 2.4 meters (7 to 8 feet). This ensures that both the front and rear wheels of a vehicle interact with multiple plates as the vehicle drives over the device. The total length of the device is generally around 3 to 4 meters (10 to 13 feet), covering the entire width of a traffic lane and ensuring that all wheels of a vehicle can engage with the plates.

Spacing between the plates is another factor. The gaps between adjacent plates are maintained at around 0.25 inches to 3 inches. This spacing is sufficient to allow for the necessary movement and flexion of each plate while ensuring that the kinetic energy is effectively transferred to the hose 206 underlying the plates.

By aligning the dimensions of the device with the typical wheelbase and vehicle dimensions, the design ensures that the wave-type interaction and fluid flow are maximized. This strategic alignment not only enhances the efficiency of energy capture and conversion but also ensures that the device can handle a wide range of vehicle sizes and types, from passenger cars to light trucks. This thoughtful consideration of dimensions and spacing underscores the device's adaptability and effectiveness in real-world applications.

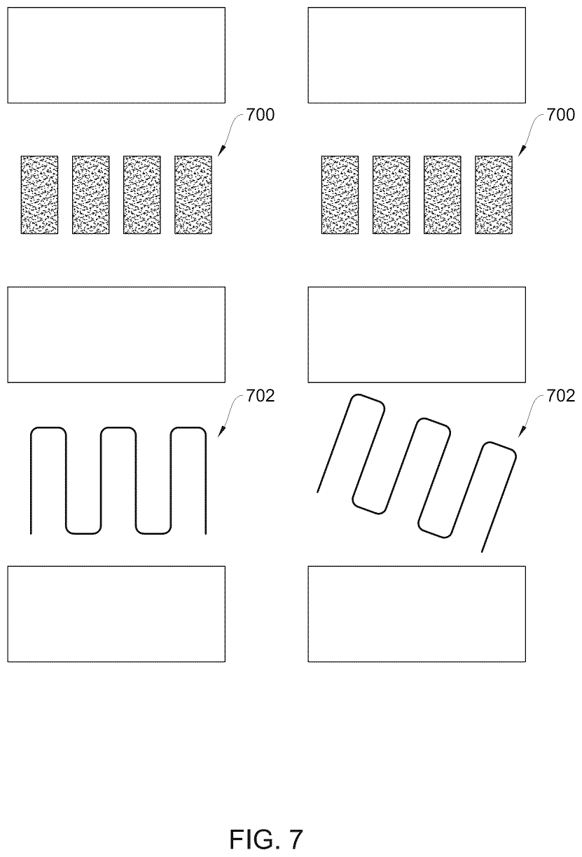

Another example apparatus or device that includes plates that run orthogonally relative to the embodiments above are shown in FIG. 7. The hose 702 is oriented in the same direction as the plates 700 (left-sided embodiment). It will be understood that the plates and hose need not run in the same direction. Other plate and hose orientations can include where the plates extend in the horizontal or vertical direction, while the hose 702 is in an angled orientation arrangement or in a parabolic arc relative to the plates 700 (left-sided embodiment). Another example includes plates that are placed at a diagonal orientation with the hose in a serpentine arrangement or in a parabolic arc. In yet another embodiment, each plate can be associated with a unique hose. The hose can be in a serpentine, parabolic, or angle orientation relative to the plate.

In an embodiment where the hoses run perpendicular to the plates, multiple hoses can be used to ensure a similar volume of fluid flow as the traditional serpentine hoses. Each hose connects to a separate hydro generator, and all hydro generators are then connected to a single inverter (converter).

Another embodiment includes a configuration where there are separate pads for each tire of the vehicle. Each pad measures approximately six feet wide by seven feet deep, allowing for one pad to be positioned under the left tires and another under the right tires of the vehicle.

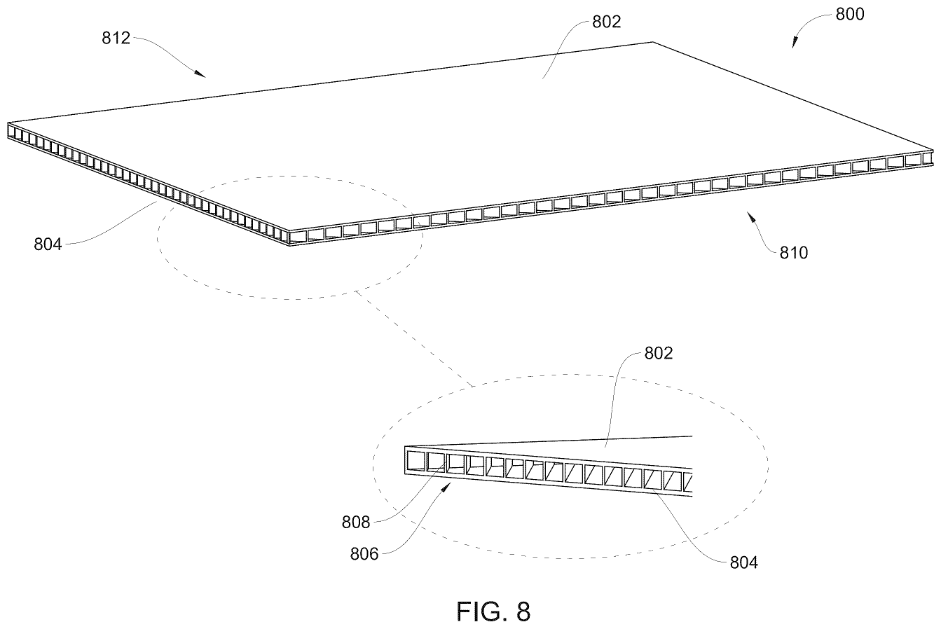

The molded rubber mat 800 in FIG. 8 comprises a bottom layer 802, a top layer 804, integrated fluid channels 806, and reinforced channel walls 808, each of which contributes to the mat's structural performance and functionality.

The bottom layer 802 forms the mat's foundational support, fabricated from a dense elastomeric material reinforced with embedded fibers or a polymeric mesh. This reinforcement enhances tensile strength and prevents deformation under heavy and repetitive loads. The bottom layer is textured to prevent slippage, ensuring stable placement on various surfaces such as roadways or industrial floors.

The top layer 804 is constructed from an abrasion-resistant elastomer with additives such as carbon black or silica to improve wear resistance and durability against environmental exposure. Its textured surface incorporates molded structural patterns designed to distribute pressure evenly and guide fluid displacement into the integrated channels 806. This top layer provides elasticity to accommodate heavy loads while maintaining its structural integrity.

The fluid channels 806 are integrally molded within the mat to direct displaced fluid efficiently. These channels are defined by reinforced channel walls 808, which are designed to resist collapse or deformation under pressure. The channel walls are fabricated from a high-strength rubber compound or a composite material to ensure long-term durability. The precise configuration and arrangement of the fluid channels 806 optimize the redirection of fluid flow during operation.

In one example, the fluid channels 806 within the molded rubber mat 800 are oriented at an angle relative to the direction of vehicle travel to enhance fluid displacement and transfer efficiency. This angled configuration allows the channels 806 to intercept and direct the force of fluid displacement more effectively as vehicles pass over the mat. By aligning the channels at a non-perpendicular angle, the design minimizes resistance to fluid movement and ensures a smoother flow toward the intended discharge points. The angular orientation also distributes the impact of vehicular loads more evenly across the channel walls 808, reducing localized stress and enhancing the overall durability of the mat. This arrangement optimizes the system's capacity to channel fluid under varying load conditions, contributing to improved performance in energy transfer applications.

The fluid channels 806 within the molded rubber mat 800 can incorporate alternating fluid channels and air-filled channels. In this embodiment, certain channels are configured to circulate fluid through the system, while others are sealed air-filled channels that remain permanently enclosed to retain compressible air.

In some instances, the fluid channels are formed directly within the molded body without separate hoses or tubes in the portion of the mat between the inlet and outlet ends; however, hoses or other fluid conduits may be included. The molded body comprises a wear-resistant upper surface for vehicle tire contact, flexible and collapsible regions surrounding the fluid channels, and weather-resistant materials rated for temperatures from −40° F. to 170° F. The fluid channels may be reinforced with braiding, support, or other materials and methods to reduce channel expansion when under compression. This reinforcement enhances durability, maintains consistent fluid displacement efficiency, and prevents deformation that could affect system performance over repeated compression cycles. The system is designed to accommodate potential temperature increases, considering that water or coolant in the system may rise by approximately 50° F. due to sunlight exposure when enclosed within black rubber or a black rubber cover.

The fluid channels function as primary energy capture elements, displacing fluid into a manifold and pressure storage system when compressed by vehicle tires. The channels are molded in such a way to accommodate designed in foldable collapse as well as rigid open self support. The air-filled channels are permanently sealed to prevent air from escaping, creating resilient compression zones that enhance the mat's ability to recover its shape after deformation. The sealed air chambers provide spring-like structural support, improving durability and maintaining system efficiency over repeated compression cycles.

The integration of both fluid and air-filled channels enables a balanced response to vehicle loads by combining fluid-driven energy capture with controlled elastic recovery. The air-filled sections reduce material fatigue and help maintain consistent surface contact for vehicles, ensuring long-term performance and structural integrity.

The molded rubber mat 800 includes an inlet end 810 and an outlet end 812, each designed to optimize fluid management and energy transfer. The inlet end 810 functions as the entry point for replenishing fluid into the system, ensuring that the fluid channels 808 remain filled and operational. This end is equipped with reinforced inlet ports made from durable, chemically resistant materials that prevent wear and leakage during prolonged use. The ports are designed to securely connect to external fluid supply systems, providing a seamless flow of fluid into the channels while maintaining pressure stability across the system.

At the opposite side, the outlet end 812 consolidates the fluid flow from the angled fluid channels 808 and directs it into an external manifold or pressure vessel, as illustrated in FIG. 9. This end incorporates reinforced junctions where the channels converge, ensuring structural integrity under the pressures generated by vehicular loads. The outlet end 812 minimizes turbulence by providing a smooth transition for the fluid, enabling efficient transfer to the external components. The combined functionality of the inlet end 810 and outlet end 812 ensures a closed-loop system that enhances fluid management and energy transfer efficiency.

While the mat 800 is constructed from a molded elastomeric body, designed for flexibility and durability under repeated compression cycles. In some embodiments, the mat 800 may include an internal reinforcement layer to enhance structural stability and impact resistance. The reinforcement layer may be implemented as a metal plate integrated within or attached to the underside of the mat 800. This metal plate serves as a rigid underlayment, providing additional durability in high-impact environments, such as roadways exposed to snowplows or heavy vehicular traffic. The metal plate may be constructed from steel, aluminum, or other high-strength materials, selected based on weight, strength, and corrosion resistance requirements.

In some embodiments, the reinforcement layer may be co-molded within the elastomeric structure, creating a bonded connection that prevents separation over time. In other implementations, the metal plate may be attached using sonic welding, heavy-duty adhesives, or mechanical fasteners, ensuring long-term structural integrity while maintaining the flexibility of the mat 800. The inclusion of a reinforcement layer enhances the impact resistance and longevity of the mat 800, enabling it to function reliably in demanding conditions while preserving its energy capture efficiency.

FIG. 9 illustrates a fluid energy transfer system centered around the molded rubber mat 800, previously described in FIG. 8, and incorporating multiple reservoirs, a pressure tank, and flow control mechanisms to manage fluid displacement, storage, and energy conversion efficiently.

The molded rubber mat 800 includes integrated fluid channels 806, as described in FIG. 8, which are angled relative to the direction of vehicle travel to optimize fluid displacement. Surrounding the mat 800 are a bottom reservoir 900, two side reservoirs 902 and 904, and a pressure bladder 906 located at the top of the system. These components work in concert to direct and store the displaced fluid for energy conversion.

The fluid channels 806 are oriented at an angle that is approximately 60 degrees relative to a reference axis R1, which aligns substantially with the direction of travel for the vehicle relative to the mat 800. While this configuration has been determined to be effective for optimizing fluid displacement efficiency and directional flow, alternative angles may be implemented depending on specific load conditions, vehicle speeds, and site requirements.

In some embodiments, the fluid channels 806 may be oriented at angles ranging from 25 degrees to 75 degrees relative to R1, allowing for adjustments to fluid displacement dynamics. A lower angle, such as 25 to 35 degrees, may be beneficial in installations where lower vehicle speeds and lighter loads result in less abrupt compression forces. A higher angle, approaching 75 degrees, may be suitable for high-traffic areas where frequent and intense compressive forces require more immediate fluid displacement.

The orientation of the fluid channels 806 also impacts the pressure recovery process within the system. Steeper angles allow for faster evacuation of displaced fluid, reducing resistance and increasing flow rate efficiency into the manifold system. Shallower angles may promote more gradual displacement, which can be advantageous in scenarios requiring controlled pressurization and smoother fluid flow distribution.

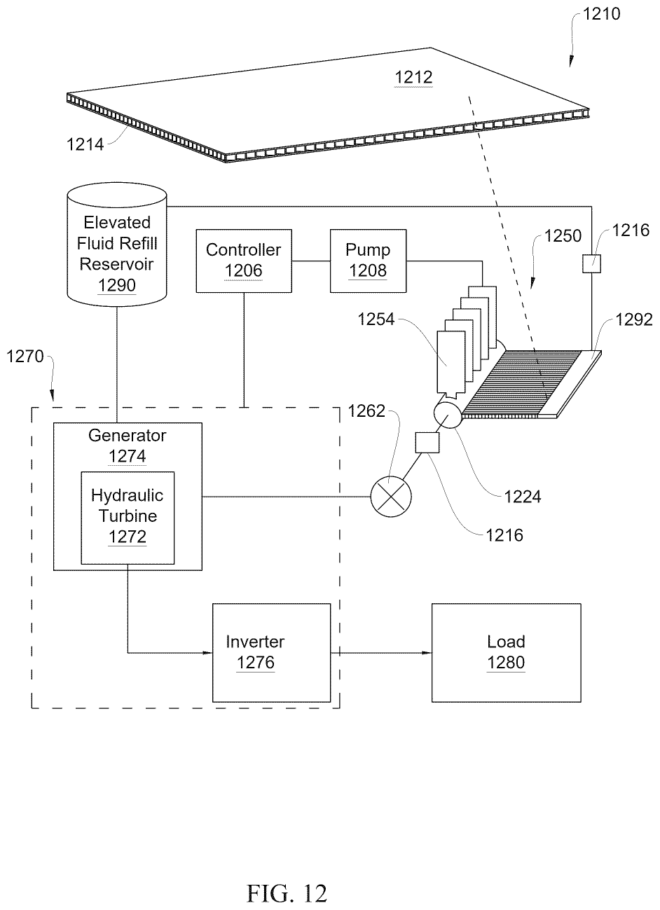

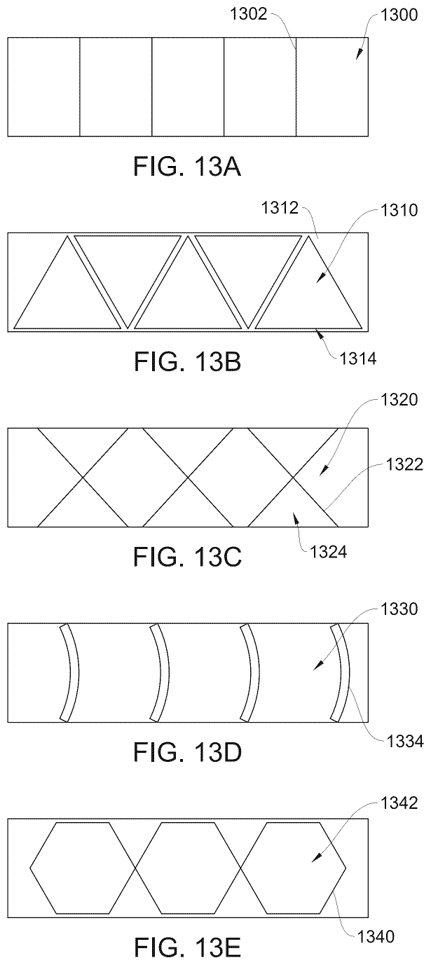

Additionally, the cross-sectional shape of the fluid channels 806 may be varied in conjunction with the channel angle to further refine fluid dynamics and structural resilience. For example, rectangular cross-sections maximize fluid volume capacity, while triangular or X-shaped configurations can enhance structural durability and energy return efficiency after compression (see FIGS. 13A-13E).

By varying the orientation, cross-sectional geometry, and integration with the manifold system, the fluid channels 806 can be optimized for a wide range of vehicular energy capture applications, ensuring efficient fluid displacement, pressure management, and durability across diverse environmental and operational conditions. Fluid enters the system via the inlet end 810 of the mat 800. Flow into the channels 806 is regulated by an inlet valve 908, which could be a check valve, flap valve, or similar mechanism to ensure unidirectional flow into the mat. Displaced fluid exits through the outlet end 812, where an outlet valve 910 controls the release of fluid from the mat 800 into the downstream components.

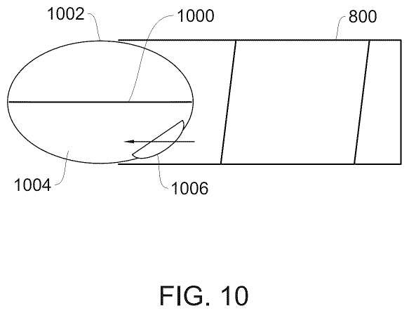

The displaced fluid first flows into the bottom reservoir 900, where it is temporarily collected and subsequently directed into the side reservoirs 902 and 904 for additional storage. From these reservoirs, fluid is transferred to the pressure bladder 906, which serves as the primary storage unit. The pressure bladder 906 separates a pressurized section of air from the fluid, maintaining consistent pressure within the system, as shown in FIG. 10.

The connections between the bottom reservoir 900, side reservoirs 902 and 904, and the pressure tank 906 are managed by flow control valves 912, 914, and 916. These valves, which may include ball valves, needle valves, or spring-loaded mechanisms, ensure precise regulation of fluid movement throughout the system. It is important to note that there is no fluid flow returning from the pressure tank 906 to the right-side reservoir 904, ensuring a unidirectional flow toward the energy conversion components. From the pressure bladder 906, the pressurized fluid is directed toward a generator 918, which incorporates a turbine or similar energy conversion device. The turbine converts the kinetic energy of the pressurized fluid into mechanical energy, which is then used to generate electricity.

Downstream of the generator 918, the system includes an external reservoir 920 designed to collect and store fluid after it has passed through the generator. This external reservoir 920 serves as a holding tank to manage fluid volumes and provide a consistent return supply for recirculation back to the inlet end 810 of the mat 800. Constructed from durable, pressure-resistant materials, the external reservoir 920 ensures that fluid is readily available for reuse, maintaining the system's efficiency and continuity during operation. In some instances, a pressure of the fluid in the external reservoir 920 can me modulated, either increasing or decreasing before adding back into the mat.

The fluid used within the vehicular energy capture system may be modified to increase its density, thereby enhancing momentum transfer, pressure retention, and overall energy conversion efficiency. By increasing the density of the displaced fluid, the system can store and transfer more kinetic energy per unit volume, improving the performance of the pressure storage assembly and energy conversion components.

In one embodiment, the fluid may be modified by incorporating high-density additives. Examples of such additives include metallic or mineral-based suspensions, such as barium sulfate, iron oxide, or tungsten powder, which can be dispersed within the fluid to increase mass without significantly altering viscosity. These materials enable the fluid to maintain efficient flow characteristics while improving energy capture.

In another embodiment, the fluid may consist of a high-density liquid, such as brine solutions, glycol-based mixtures, or synthetic hydraulic fluids, which inherently possess greater density compared to standard water-based fluids. These liquids may also offer additional benefits, such as freeze protection and corrosion resistance, depending on environmental conditions.

Alternatively, the fluid may be formulated as a nanoparticle-enhanced suspension, incorporating silica, ceramic, or metallic nanoparticles to increase density while retaining optimal flow properties. This approach allows for customized density control, enabling fine-tuning based on installation requirements and expected vehicular loads.

The selection of density-enhancing additives or alternative high-density fluids may be based on factors such as viscosity stability, thermal expansion properties, environmental impact, and long-term material compatibility with the system's manifolds, valves, and pressure storage components. These modifications allow the fluid energy transfer system to be optimized for specific roadway conditions, traffic loads, and energy conversion requirements.

Referring to FIG. 10, a cross-sectional view of a pressure bladder 906 is illustrated as part of the fluid energy transfer system. The pressure bladder 906 is configured to receive and store fluid displaced from the molded rubber mat 800 while maintaining pressure equilibrium through a compressed air chamber 1002. The pressure bladder 906 is divided into two chambers by a flexible membrane 1000, which separates compressed air from the incoming displaced fluid.

The upper chamber 1002 contains compressed air, which serves to maintain consistent pressure within the system. The air pressure can be pre-set to a specific level depending on the operational requirements of the system, ensuring efficient energy transfer during fluid displacement. The compressed air provides the necessary force to expel stored fluid when required for energy conversion or recirculation within the system.

The fluid chamber 1004, located below the membrane 1000, receives fluid displaced from the mat's fluid channels 806. This chamber accommodates variable volumes of fluid, with the membrane 1000 flexing accordingly to maintain a pressure balance between the air and fluid chambers. The membrane 1000 is constructed from a reinforced elastomer or thermoplastic polyurethane (TPU), ensuring long-term durability and resistance to degradation over repeated compression cycles.

When a vehicle drives over the molded rubber mat 800, the displaced fluid enters the fluid chamber 1004, exerting upward pressure against the membrane 1000. As the membrane 1000 flexes, it compresses the air in the upper chamber 1002, increasing the internal air pressure. This pressurized air acts as a counterbalance to the incoming fluid, ensuring stable pressure conditions within the pressure bladder 906.

A one-way valve 1006 is positioned along the fluid outlet path, allowing displaced fluid to exit the fluid chamber 1004 while preventing backflow into the molded rubber mat 800. The one-way valve 1006 may be configured as a spring-loaded check valve, a reed valve, or a diaphragm valve, depending on operational requirements and environmental conditions. The spring-loaded check valve opens under pressure from the displaced fluid and automatically closes when fluid displacement ceases, ensuring unidirectional flow. The reed valve flexes to permit outward flow and seals when backpressure is detected, providing a simple and low-maintenance solution. The diaphragm valve utilizes a flexible membrane that opens under differential pressure, ensuring fluid is directed only toward the pressure storage system. In some instances, the valve may also be pre-molded into the mat, such as the sidewalls that separate the fluid channels from the fluid chambers or bladders/manifolds.

The controlled fluid displacement from the fluid chamber 1004 ensures that pressurized fluid is efficiently delivered to the generator 916 for energy conversion or recirculation into the system. The one-way valve 1006 plays a critical role in maintaining system efficiency, preventing unwanted fluid backflow, and ensuring that the fluid energy transfer system remains pressurized for optimal performance.

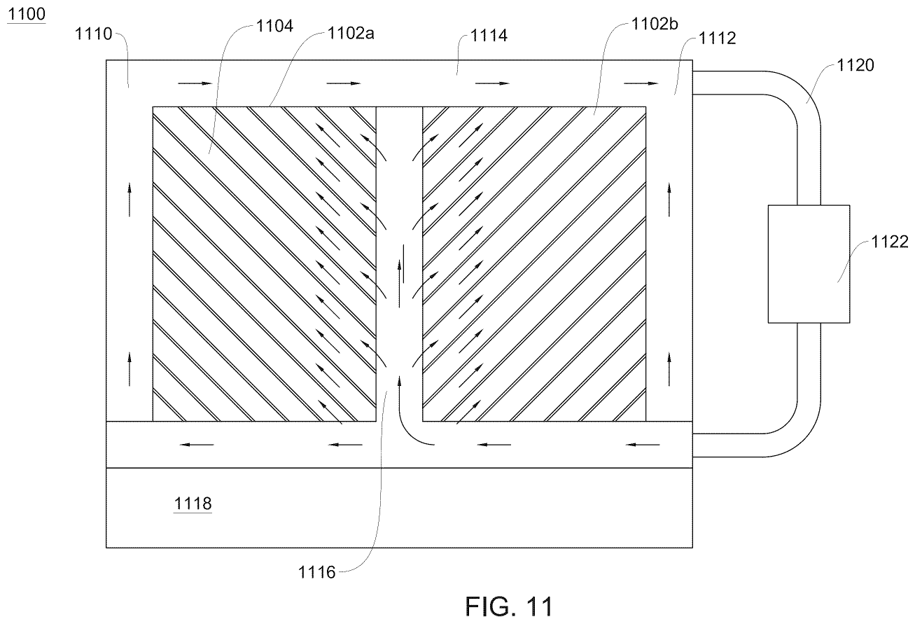

Referring to FIG. 11, a dual-mat fluid management system is illustrated. The system includes two molded rubber mats 1102a and 1102b, positioned side by side, each integrating angled fluid channels 1104 configured to direct displaced fluid toward designated flow pathways. The system is designed to capture and redistribute fluid under vehicular loads, transferring the stored energy to a generator for energy conversion. The mats 1102a and 1102b are similar in construction to mat 800 of FIG. 8, incorporating a molded structure with integrated fluid channels and a wear-resistant surface for vehicular traffic.

The fluid channels 1104 are oriented diagonally within each mat to optimize fluid displacement. The left-side mat 1102a directs fluid toward a first pressure storage area 1110 located along the left edge of the system. Similarly, the right-side mat 1102b directs fluid to a second pressure storage area 1112 positioned along the right edge. Channels on the upper edges of both mats direct fluid to a third pressure storage area 1114, located along the top portion of the system. The angled fluid channels ensure efficient displacement and flow of fluid toward the outer storage areas while maintaining pressure equilibrium across the mats.

A fluid refill channel 1116 is centrally located between the two mats. Displaced fluid from the first, second, and third pressure storage areas 1110, 1112, and 1114 is redirected into this central refill channel 1116, ensuring continuous fluid replenishment across the system. The fluid refill channel maintains fluid circulation, allowing the mats to sustain efficient operation under repeated vehicular loads.

A reset plate 1118 is positioned along the lower edge of the system. The reset plate may facilitate the return of fluid to the fluid refill channel 1116, ensuring consistent operation by directing any residual fluid back into the system. The reset plate 1118 is omitted in some embodiments.

The fluid outlet flow path 1120 directs displaced fluid from the mats toward a generator system 1122. The generator system is positioned on the right-hand side of the system and may be elevated to facilitate gravity-assisted fluid flow into the generator assembly. The generator system utilizes pressurized fluid to drive a turbine or other energy conversion components, converting mechanical energy into electrical power.

Referring to FIG. 12, a vehicular energy capture and pressure storage system is disclosed in accordance with an alternative embodiment. The system 1200 is designed to capture fluid displaced by vehicular compression, regulate the stored pressure, and convert the stored energy into electrical power. The system 1200 includes a vehicular energy capture mat 1210, a pressure storage assembly 1250, and an energy conversion assembly 1270. The vehicular energy capture mat 1210 is structurally similar to the mat 800 of FIG. 8, incorporating a molded structure with integrated fluid channels 1214 and a wear-resistant surface for vehicular traffic.

The vehicular energy capture mat 1210 includes a molded flexible body 1212, housing a plurality of integrated fluid channels 1214, which are configured to displace fluid when compressed by vehicular loads. The displaced fluid is initially directed into a primary manifold 1224, positioned within or adjacent to the mat 1210. The primary manifold 1224 serves as the first-stage collection system, receiving fluid from the fluid channels 1214 and directing it toward the pressure storage assembly 1250. The primary manifold 1224 may also include one or more check valves to regulate flow direction and prevent backflow.

The pressure storage assembly 1250 comprises one or more pressurized storage reservoirs, including either a bladder tank or a vertical air-fluid storage tank 1254. In the bladder tank configuration, a flexible bladder separates a pressurized air chamber from a fluid chamber, enabling controlled pressure retention. In the vertical air-fluid storage tank 1254, displaced fluid enters a vertical storage chamber, compressing an air pocket at the upper portion of the tank to maintain a stable internal pressure. In some instances, a bladder is omitted and the air above the fluid exerts pressure alone.

The pressure storage assembly 1250 is configured to store pressurized fluid and release the stored energy in a controlled manner to the energy conversion assembly 1270. The pressurized fluid is discharged through a pressure regulation assembly 1260, which includes a pressure-regulating check valve 1262. This check valve ensures the stored fluid exits at a consistent pressure level, such as 30 PSI, optimizing the energy transfer efficiency of the energy conversion assembly 1270. Regulator (such as a check valve) may be self-adjusting, either, mechanically or electronically, based upon the pressure and flow seen at 1216. This allows more energy to be harvested from heavier and faster vehicles.

The pressure regulation assembly 1260 may incorporate a pressure-compensated flow control valve system that automatically adjusts to optimize energy capture based on vehicle characteristics. This system utilizes feedback from pressure sensor 1216 in the initial fluid displacement zone of the mat, which detects both the weight and speed characteristics of vehicles through the developed fluid pressure and flow rate. For example, when a heavy vehicle like a truck passes over the mat at significant speed, the initial fluid displacement creates high flow and develops high pressure. The pressure-compensated flow control valve 1262 responds by partially closing to maintain optimal flow conditions. This controlled restriction allows the system to generate and maintain higher pressure while regulating the fluid discharge rate to the turbine, preventing system overload while maximizing energy capture.

Conversely, when a lighter vehicle such as a compact car passes over the mat at lower speed, the initial fluid displacement creates lower flow and pressure. The pressure-compensated flow control valve 1262 responds by opening wider to allow the developed pressure to maintain consistent, though shorter duration, flow to the turbine. This adaptive response ensures efficient energy capture across a wide range of vehicle weights and speeds.

The pressure-compensated flow control valve 1262 may be implemented through mechanical or electronic means. In mechanical implementations, the valve uses direct pressure feedback to modulate its opening, while electronic implementations may use pressure sensor data to control valve actuation. This self-adjusting capability enables the system to automatically optimize energy capture for each vehicle interaction without requiring external control inputs.

The energy conversion assembly 1270 includes a hydraulic turbine 1272, which is driven by the released pressurized fluid. The hydraulic turbine 1272 is mechanically coupled to a generator 1274, which converts the mechanical energy into electrical power. The generated electricity is then routed to an inverter 1276, where it is conditioned for compatibility with external electrical systems. The energy conversion assembly 1270 may incorporate different types of generators, including a rotary generator, an alternator, a linear generator, or a magnetohydrodynamic generator, depending on system requirements. The alternator configuration may be selected for compact and low-maintenance applications, while the linear generator may be utilized for direct displacement energy conversion. The magnetohydrodynamic generator can be employed in high-efficiency installations utilizing conductive fluids for optimized energy transfer.

The pressure storage assembly 1250 is positioned adjacent to the vehicular energy capture mat 1210, with vertical air-fluid storage tanks 1254 arranged to optimize spatial efficiency. Structural reinforcements, such as buffer plates or curb-like protective enclosures, may be included to prevent vehicle impact with the pressure storage assembly 1250.

The system 1200 may be implemented with alternative storage geometries, including cylindrical, rectangular, or modular interconnecting reservoirs. A bladder tank may be fabricated from polymeric elastomers, reinforced composites, or thermoplastic-coated fabrics for improved durability. The vertical air-fluid storage tanks 1254 may be constructed from PVC, ABS, metal, or composite materials, incorporating internal coatings for corrosion resistance.

In some configurations, the energy conversion assembly 1270 may be designed to operate using alternators instead of generators, providing flexibility in electrical configurations. The pressure-regulating check valve 1262 may be adjustable to accommodate varying vehicle loads, ensuring dynamic energy optimization.

The vertical air-fluid storage tanks 1254 may also allow for variable pressure control, optimizing fluid retention, pressure staging, and controlled energy release. The system may adjust the air pocket within the tanks to modify internal pressure characteristics, ensuring the appropriate pressure output based on vehicle load, traffic density, and operational requirements.

A dynamic pressure regulation mechanism may be incorporated into the system, enabling adaptive adjustments to the fluid intake and air compression levels. This feature allows the storage tanks 1254 to respond to fluctuating vehicular loads, maintaining optimal energy recovery efficiency without excessive pressure loss.

The vertical air-fluid storage tanks 1254 may be arranged in staged configurations, where multiple tanks with varying pressures are connected in series or parallel arrangements. This staged configuration enables a controlled, multi-phase release of pressurized fluid, ensuring that the energy conversion assembly 1270 receives fluid at an optimal and consistent pressure level.

The pressure-regulating check valve 1262 may be configured to operate in conjunction with variable pressure storage, dynamically adjusting to accommodate different operating conditions. This enhances the efficiency and adaptability of the system 1200, allowing for customization based on specific roadway environments and energy demands.

The modular nature of the energy conversion assembly 1270 allows for seamless integration with renewable energy infrastructure, such as solar or wind power systems, enabling hybrid energy solutions. The electrical output from the generator 1274 may be directed to an external load 1280, representing various electrical applications.

Downstream from the energy conversion assembly 1270 is an elevated fluid refill reservoir 1290, which is hydraulically coupled to a secondary or refill manifold 1292. The fluid refill reservoir 1290 serves as a gravity-fed supply system, ensuring that displaced fluid is recirculated back into the vehicular energy capture mat 1210. This closed-loop system supports continuous energy capture and fluid displacement, maintaining system efficiency under repeated vehicular loads.

According to some embodiments, a control system 1206 is integrated into the vehicular energy capture and pressure storage system 1200 to manage various operational aspects of fluid displacement, pressure regulation, and energy conversion. The control system 1206 interfaces with multiple system components, including the pressure storage assembly 1250, the pump 1208, the elevated fluid refill reservoir 1290, and the energy conversion assembly 1270.

The control system 1206 can regulate fluid displacement and pressure management by adjusting the operation of the pump 1208. This allows controlled fluid movement between the secondary manifold 1292, the primary pressure storage tanks 1254, and the elevated fluid refill reservoir 1290. By dynamically managing fluid flow, the control system 1206 can optimize pressure retention, staged fluid release, and energy conversion efficiency.

The control system 1206 can also monitor and adjust the air pressure within the vertical air-fluid storage tanks 1254. This functionality ensures that the system maintains an optimal balance between fluid and air compression, allowing for real-time pressure adjustments to match vehicle traffic loads. By controlling the air volume in the storage tanks, the system can increase or decrease internal pressure levels, improving energy storage and efficiency in different operating conditions.

In addition, the control system 1206 can influence the operation of the energy conversion assembly 1270, including the hydraulic turbine 1272 and the generator 1274. This capability allows the system to release stored pressurized fluid strategically, such as during peak energy demand periods, and regulate turbine operation to maintain a consistent power output.

The control system 1206 is configured to monitor various operational parameters of the vehicular energy capture and pressure storage system 1200 in real time. The control system 1206 is operably connected to one or more sensors 1216, which may include pressure sensors, fluid level sensors, and temperature sensors, each providing data for system optimization and operational adjustments.

The pressure sensors 1216 play a particularly important role in the priming section of the mat, where initial vehicle contact occurs. These sensors measure both the magnitude and rate of pressure development as vehicles enter the system. This data serves as key input for the pressure-compensated flow control valves, enabling real-time adjustment of fluid flow based on vehicle characteristics. The pressure profile detected in this initial zone provides crucial information about vehicle weight and speed, allowing the system to optimize its response for maximum energy capture while maintaining safe operating conditions.

The sensors 1216 may include at least one pressure sensor, positioned along the fluid pathways and within the pressure storage assembly 1250, configured to detect real-time pressure levels within the system. The pressure sensor may be an absolute pressure sensor, differential pressure sensor, or piezoelectric pressure sensor, ensuring accurate monitoring of fluid compression, air chamber pressure, and system equilibrium.

The sensors 1216 may also include at least one fluid level sensor, positioned within the vertical air-fluid storage tanks 1254, configured to measure the volume of displaced fluid stored in the system. The fluid level sensor may be a capacitive level sensor, ultrasonic level sensor, or float-based sensor, enabling precise fluid volume tracking for energy capture efficiency and pressure balancing.

Additionally, the sensors 1216 may include at least one temperature sensor, configured to monitor temperature variations within the fluid pathways, storage reservoirs, and energy conversion assembly 1270. The temperature sensor may be a thermocouple, resistance temperature detector (RTD), or infrared temperature sensor, enabling active temperature monitoring to prevent overheating, freezing, or thermal inefficiencies within the system.

The control system 1206 is further configured to analyze the sensor data in real-time, providing automated feedback to regulate pressure levels, fluid displacement rates, and energy conversion parameters. The sensor feedback loop enables the system to make dynamic adjustments, ensuring efficient energy transfer, predictive maintenance, and adaptive system management based on real-time operating conditions.

Additionally, the system 1200 may process traffic-related data, including vehicle weight, frequency, and speed, captured through integrated load sensors, inductive loop sensors, or optical sensors. This data may be utilized for maintenance scheduling, system diagnostics, and adaptive energy capture adjustments, optimizing system performance based on roadway usage patterns and vehicular activity.

Referring now to FIGS. 13A-13E, several alternative fluid channel cross-sectional configurations for the vehicular energy capture mat are disclosed. Each of these configurations provides distinct structural and operational advantages based on material properties, fluid flow characteristics, and energy capture efficiency. The cross-sectional variations are designed to optimize fluid displacement, resilience under vehicular loads, and durability over repeated compression cycles.

FIG. 13A illustrates a rectangular cross-sectional channel 1300, similar to the integrated channels of mat 800 in FIG. 8, having substantially straight vertical walls 1302 and a flat top and base. This configuration provides maximum internal fluid volume while maintaining a consistent shape under compression. The vertical walls 1302 may be reinforced to prevent excessive deformation under repeated vehicular loads.

FIG. 13B illustrates a triangular cross-sectional channel 1310, where alternating upward-facing peaks 1312 and downward-facing troughs 1314 create a series of fluid passageways that provide improved structural resilience. The triangular geometry enhances spring-back characteristics, allowing the mat to recover more efficiently after compression. This configuration may also reduce lateral expansion of the mat under load, preserving structural integrity over prolonged use.

FIG. 13C illustrates an X-shaped cross-sectional channel 1320, incorporating intersecting internal walls 1322 to divide the fluid channel into four sub-chambers 1324. This configuration improves pressure distribution and minimizes localized stress on the mat material. The intersecting walls 1322 may provide additional structural reinforcement, reducing the risk of material fatigue over extended operational cycles.

FIG. 13D illustrates a D-shaped cross-sectional channel 1330, having a flat top and based substrates and a plurality of curved sidewalls 1334. This design enhances fluid compression efficiency by allowing the curved sidewalls to flex more uniformly under load. The curved sidewalls 1334 provides gradual deformation when compressed, reducing peak stress concentrations that could lead to material degradation.

FIG. 13E illustrates a hexagonal cross-sectional channel 1340, forming a honeycomb-like structure that provides enhanced load distribution and multi-directional compression resistance. The multiple flat surfaces 1342 allow for predictable deformation patterns, which can improve energy recovery efficiency. The hexagonal design may also increase structural strength while maintaining sufficient internal volume for fluid displacement.

A mat can also integrate multiple geometries within a single mat configuration. One embodiment may combine triangular, rectangular, and curved sections to achieve an optimal balance of fluid volume, material resilience, and energy recovery efficiency. The hybrid structure allows for customized performance characteristics, where specific regions of the mat can be tailored for different load conditions.

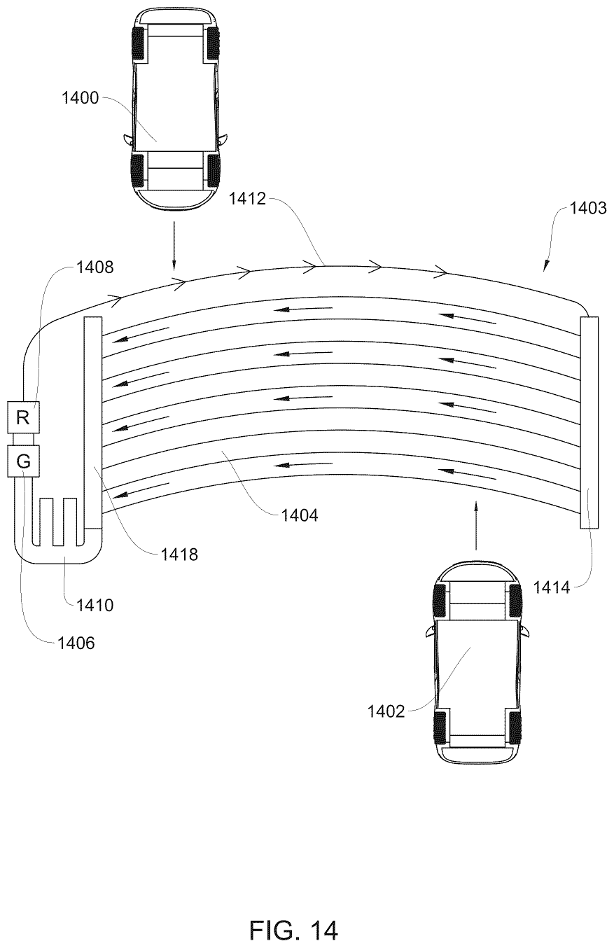

FIG. 14 illustrates a two-way traffic fluid flow system installed across a total width sufficient to span two traffic lanes. Vehicles traveling from a first direction are shown at the upper vehicle approach 1400 and a lower approach 1402. As such vehicles traverse the fluid capture area or mat 1403, their wheels compress crescent-shaped fluid channels 1404 formed in a resilient material, thereby displacing a volume of fluid into the manifold or plenum 1418. The system simultaneously accommodates opposing traffic flow, exemplified by the lower vehicle approach 1402 who also encounter crescent-shaped fluid channels 1404. Each channel is internally reinforced to withstand repeated vehicular compression and maintain proper fluid displacement characteristics for optimal kinetic energy transfer.

The crescent-shaped fluid channel array 1404 is configured to intersect approaching wheels at an advantageous angle, regardless of travel direction. As fluid is displaced, it travels along the connecting manifold or plenum 1418 toward the generator 1406, which houses a hydro turbine. The hydro turbine is constructed with a central rotor, multiple radially extending blades, and an associated drive shaft that couples to an electrical generator component. When the displaced fluid impinges upon the blades, the rotor spins to produce electrical energy. This electrical energy may be routed to an inverter, a power controller, or a grid-tied system, depending on installation requirements.

Positioned proximate the generator 1406 is the reservoir 1408, arranged so that fluid exiting the turbine is directed downward into a collection chamber by gravitational force. The reservoir 1408 includes a sealed lower portion for stable fluid containment and a portion designed to align with the turbine outlet, ensuring minimal fluid loss. The direct arrangement between the generator 1406 and the reservoir 1408 minimizes the need for secondary pumps and enables a compact system footprint suitable for roadway installations.

A vertical storage container 1410 is located in lateral proximity to the generator 1406 to regulate fluid pressure in real time as multiple vehicles of varying weights compress the fluid channels 1404. This container 1410 may comprise a cylindrical or rectangular enclosure, fabricated from high-strength materials to withstand repeated pressurization. Within the vertical storage container 1410, a portion of the fluid is maintained under controlled compression, thereby providing a buffer zone to accommodate surges from heavier vehicles without over-pressurizing the turbine.

A refill line 1412 is formed along an upper region of the system. This line 1412 reintroduces fluid into the crescent-shaped channels 1404, ensuring that sufficient fluid volume is continually available for energy capture. The refill line 1412 may include check valves or flow controllers to maintain a unidirectional path and prevent backflow when the channels 1404 are compressed. Connected to the refill line 1412 is the refill chamber 1414, which stabilizes fluid flow by functioning as a staging area prior to reentry into the main channel array. The chamber 1414 may incorporate level sensors or a sight gauge to indicate fluid volume, promoting consistent refilling operations under varying traffic conditions.

The connecting pathway 1416 extends between the generator 1406 and the reservoir 1408, ensuring that displaced fluid flows directly into the turbine and is then deposited in the reservoir 1408 under gravity. The connecting pathway 1418 couples the channel array 1404 with the generator 1406, guiding pressurized fluid through internal conduits that minimize flow resistance and turbulence. A connecting pathway is arranged between the refill chamber 1414 and the crescent-shaped channels 1404 to facilitate complete circuit closure, allowing fluid to be drawn from the refill chamber 1414 whenever a channel segment requires replenishment.

In operation, vehicular weight from both traffic lanes compresses the fluid channels 1404, forcing fluid through the connecting manifold or plenum 1418 into the generator 1406. The pressurized fluid activates the hydro turbine, which rotates and produces electrical power. Once released, fluid falls into the reservoir 1408 and may be temporarily stored in the vertical storage container 1410 to accommodate pressure fluctuations caused by heavy or successive vehicles. The refill line 1412 and refill chamber 1414 continuously supply fluid back to the channels 1404, ensuring that each subsequent wheel load drives a fresh fluid displacement cycle. This integrated design provides efficient two-way energy capture while consolidating all electronics, including the generator 1406, on one lateral side of the roadway to reduce manufacturing and maintenance complexities.

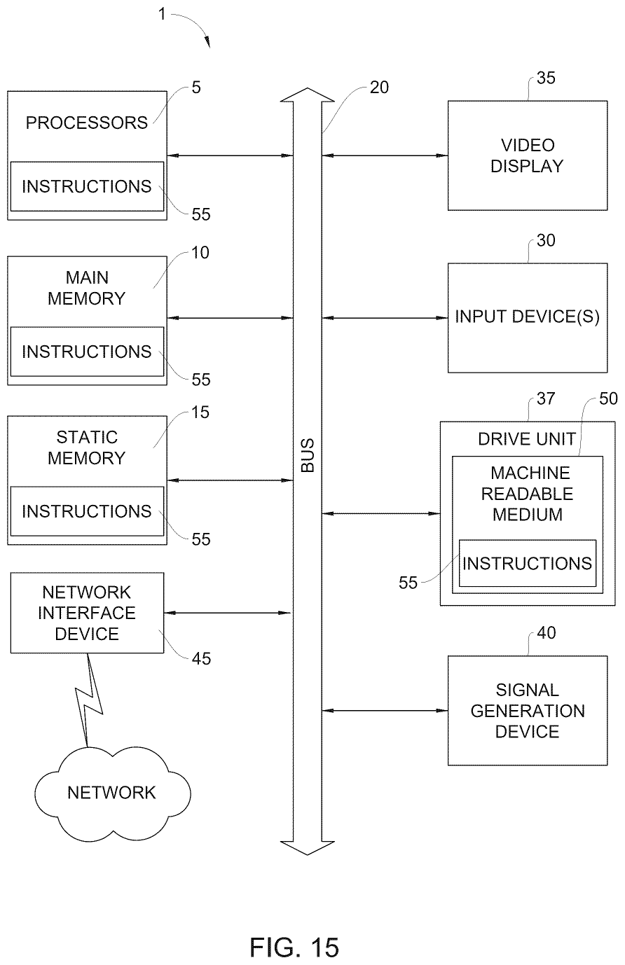

FIG. 15 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

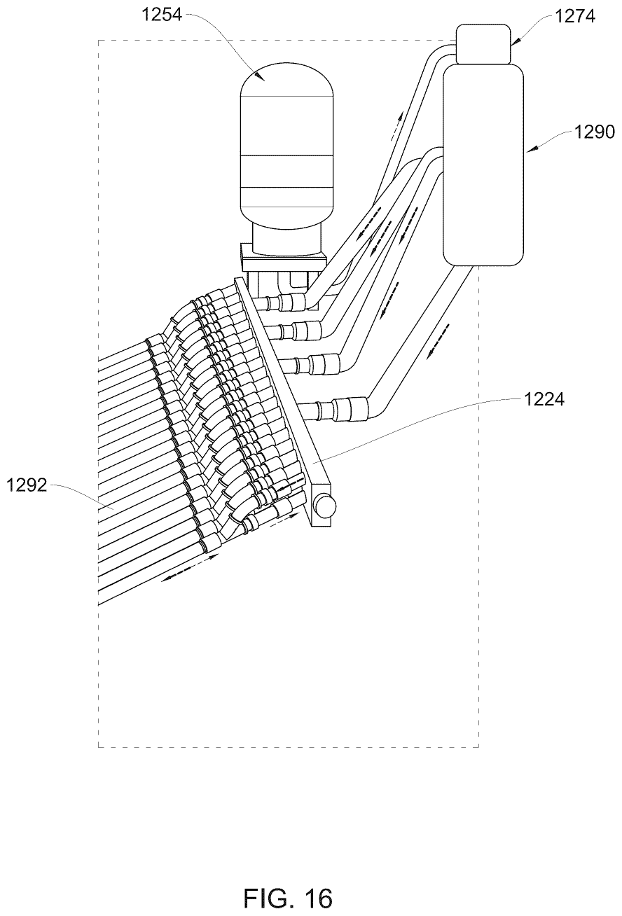

FIG. 16 depicts a sub-assembly configuration of the energy conversion and fluid management components that correspond to the vehicular energy capture and pressure storage system described in FIG. 12. This sub-assembly view illustrates the physical arrangement and interconnection of the pressure storage assembly 1250, energy conversion assembly 1270, and fluid circulation elements that facilitate the conversion of captured kinetic energy into electrical power.

The sub-assembly includes a plurality of pressure storage tanks 1254, which correspond to the vertical air-fluid storage tanks 1254 referenced in the pressure storage assembly 1250 of FIG. 12. The pressure storage tanks 1254 are positioned to receive pressurized fluid displaced from the vehicular energy capture mat through the primary manifold 1224. Each pressure storage tank 1254 can be configured as a vertical air-fluid storage tank or bladder tank, maintaining pressurized fluid for controlled release to the energy conversion assembly 1270.

The generator 1274 is positioned to receive pressurized fluid from the pressure storage tanks 1254 through the pressure regulation assembly 1260 and convert the fluid energy into electrical power. The generator 1274 corresponds to the generator 1274 shown in the energy conversion assembly 1270 of FIG. 12 and includes a hydraulic turbine 1272 mechanically coupled to the electrical generator. The generator 1274 can be implemented as a rotary generator, alternator, linear generator, or magnetohydrodynamic generator depending on system requirements.

A refill reservoir 1290 is positioned within the sub-assembly to collect fluid after energy conversion and provide gravity-fed recirculation back to the vehicular energy capture mat 1210. The refill reservoir 1290 corresponds to the elevated fluid refill reservoir 1290 described in FIG. 12, maintaining continuous fluid availability through the secondary manifold 1292. The refill reservoir 1290 is elevated relative to the mat to facilitate gravity-assisted fluid return through the circulation pathways.

Fluid interconnections between the components are facilitated through a network of hoses 1292 and manifold connections. The hoses 1292 provide flexible fluid pathways between the pressure storage tanks 1254, generator 1274, and refill reservoir 1290, enabling controlled fluid flow throughout the energy conversion cycle. Flow direction and pressure regulation can be managed through inlet check valves 1226 and outlet check valves 1226 positioned at strategic locations within the fluid pathways, corresponding to the pressure-regulating check valve 1262 described in the pressure regulation assembly 1260 of FIG. 12.

The sub-assembly arrangement shown in FIG. 16 enables modular installation and maintenance of the energy conversion components while implementing the system architecture described schematically in FIG. 12. The physical separation of the pressure storage assembly 1250, energy conversion assembly 1270, and fluid circulation components allows for independent servicing and optimization of each functional element while maintaining the closed-loop fluid circulation necessary for continuous energy capture and conversion operations.

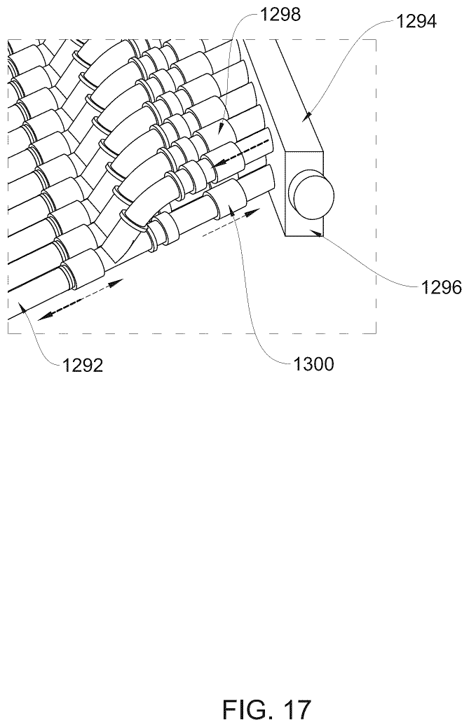

FIG. 17 depicts a detailed view of the fluid pathway interconnections, check valve arrangements, and manifold configurations that facilitate controlled fluid flow within the vehicular energy capture and pressure storage system 1200 of FIG. 12. This detailed view illustrates the specific implementation of fluid flow control mechanisms that ensure unidirectional fluid movement and optimal energy transfer efficiency throughout the system.

The detailed view shows an inlet supply manifold 1294 positioned to receive and distribute fluid from the elevated fluid refill reservoir 1290 described in FIG. 12. The inlet supply manifold 1294 provides a centralized distribution point for directing fluid into the individual hoses 1302 that connect to the vehicular energy capture mat 1210. The manifold design enables simultaneous fluid supply to multiple parallel fluid channels while maintaining consistent pressure distribution across the mat system.

An inlet check valve 1298 is positioned along the inlet fluid pathway to regulate fluid flow direction and prevent backflow from the mat system into the refill reservoir 1290. The inlet check valve 1298 corresponds to the flow control mechanisms described in the pressure regulation assembly 1260 of FIG. 12 and can be implemented as a spring-loaded check valve, reed valve, or diaphragm valve depending on operational requirements. The inlet check valve 1298 opens under forward pressure from the refill reservoir 1290 and automatically closes when differential pressure decreases, ensuring unidirectional flow into the mat system.

A plurality of hoses 1292 extend from the inlet supply manifold 1294 to provide flexible fluid pathways between the manifold and the individual fluid channels within the vehicular energy capture mat 1210. The hoses 1292 are constructed from durable, flexible materials capable of withstanding repeated pressure cycles and environmental exposure. Each hose 1292 can be equipped with individual flow control mechanisms to regulate fluid distribution to specific sections of the mat system.

An outlet supply manifold 1296 is positioned to collect pressurized fluid displaced from the vehicular energy capture mat 1210 and direct the fluid toward the pressure storage assembly 1250. The outlet supply manifold 1296 consolidates fluid flow from multiple mat channels and provides a centralized collection point for directing high-pressure fluid to the pressure storage tanks 1254. The manifold design minimizes turbulence and pressure losses during fluid collection and transfer operations.

An outlet check valve 1300 is positioned along the outlet fluid pathway to maintain unidirectional flow from the mat system toward the pressure storage assembly 1250. The outlet check valve 1300 prevents backflow from the pressure storage tanks 1254 into the mat system, ensuring that stored pressure is maintained for controlled release to the energy conversion assembly 1270. The outlet check valve 1300 opens under pressure from fluid displacement within the mat and automatically closes when mat compression ceases, maintaining system pressure integrity.

The interconnection arrangement shown in FIG. 17 enables precise control of fluid flow direction and pressure management throughout the vehicular energy capture and pressure storage system. The combination of inlet and outlet check valves 1298 and 1300 with the manifold distribution system ensures that fluid moves in the intended direction through the energy capture cycle, from the refill reservoir 1290 through the mat system to the pressure storage assembly 1250, and ultimately to the energy conversion assembly 1270.
The detailed fluid pathway configuration allows for modular installation and maintenance of the flow control components while maintaining the closed-loop circulation necessary for continuous energy capture operations. The manifold and check valve arrangement can be scaled to accommodate different mat sizes and configurations while preserving the fundamental flow control principles that optimize energy transfer efficiency throughout the system.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

The corresponding structures, materials, acts, and equivalents of all means or step plus function elements in the claims below are intended to include any structure, material, or act for performing the function in combination with other claimed elements as specifically claimed. The description of the present technology has been presented for purposes of illustration and description, but is not intended to be exhaustive or limited to the present technology in the form disclosed. Many modifications and variations will be apparent to those of ordinary skill in the art without departing from the scope and spirit of the present technology. Exemplary embodiments were chosen and described in order to best explain the principles of the present technology and its practical application, and to enable others of ordinary skill in the art to understand the present technology for various embodiments with various modifications as are suited to the particular use contemplated.

If any disclosures are incorporated herein by reference and such incorporated disclosures conflict in part and/or in whole with the present disclosure, then to the extent of conflict, and/or broader disclosure, and/or broader definition of terms, the present disclosure controls. If such incorporated disclosures conflict in part and/or in whole with one another, then to the extent of conflict, the later-dated disclosure controls.

The terminology used herein can imply direct or indirect, full or partial, temporary or permanent, immediate or delayed, synchronous or asynchronous, action or inaction. For example, when an element is referred to as being “on,” “connected” or “coupled” to another element, then the element can be directly on, connected or coupled to the other element and/or intervening elements may be present, including indirect and/or direct variants. In contrast, when an element is referred to as being “directly connected” or “directly coupled” to another element, there are no intervening elements present.

The terminology used herein is for the purpose of describing particular embodiments only and is not intended to be necessarily limiting of the disclosure. As used herein, the singular forms “a,” “an” and “the” are intended to include the plural forms as well, unless the context clearly indicates otherwise. The terms “comprises,” “includes” and/or “comprising,” “including” when used in this specification, specify the presence of stated features, integers, steps, operations, elements, and/or components, but do not preclude the presence or addition of one or more other features, integers, steps, operations, elements, components, and/or groups thereof.

Example embodiments of the present disclosure are described herein with reference to illustrations of idealized embodiments (and intermediate structures) of the present disclosure. As such, variations from the shapes of the illustrations as a result, for example, of manufacturing techniques and/or tolerances, are to be expected. Thus, the example embodiments of the present disclosure should not be construed as necessarily limited to the particular shapes of regions illustrated herein, but are to include deviations in shapes that result, for example, from manufacturing.

Aspects of the present technology are described above with reference to flowchart illustrations and/or block diagrams of methods, apparatus (systems) and computer program products according to embodiments of the present technology. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In this description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” or “according to one embodiment” (or other phrases having similar import) at various places throughout this specification are not necessarily all referring to the same embodiment. Furthermore, the particular features, structures, or characteristics may be combined in any suitable manner in one or more embodiments. Furthermore, depending on the context of discussion herein, a singular term may include its plural forms and a plural term may include its singular form. Similarly, a hyphenated term (e.g., “on-demand”) may be occasionally interchangeably used with its non-hyphenated version (e.g., “on demand”), a capitalized entry (e.g., “Software”) may be interchangeably used with its non-capitalized version (e.g., “software”), a plural term may be indicated with or without an apostrophe (e.g., PE's or PEs), and an italicized term (e.g., “N+1”) may be interchangeably used with its non-italicized version (e.g., “N+1”). Such occasional interchangeable uses shall not be considered inconsistent with each other.

Also, some embodiments may be described in terms of “means for” performing a task or set of tasks. It will be understood that a “means for” may be expressed herein in terms of a structure, such as a processor, a memory, an I/O device such as a camera, or combinations thereof. Alternatively, the “means for” may include an algorithm that is descriptive of a function or method step, while in yet other embodiments the “means for” is expressed in terms of a mathematical formula, prose, or as a flow chart or signal diagram.

What is claimed is:

1. A vehicular energy capture mat comprising:
a unitary molded mat body having a substantially polygonal shape, the unitary molded mat body comprising:
a first plurality of parallel primary fluid flow channels integrally formed within the unitary molded mat body;
wherein adjacent ones of the first plurality of parallel primary fluid flow channels share integral dividing walls within the unitary molded mat body, the first plurality of parallel primary fluid flow channels are arranged in a uniform repeating pattern across a width of the unitary molded mat body;
a first edge manifold channel extending along a first edge of the unitary molded mat body;
a second edge manifold channel extending along a second edge of the unitary molded mat body opposite the first edge; and
wherein each of the first plurality of parallel primary fluid flow channels is in fluid communication with both the first edge manifold channel and the second edge manifold channel and wherein the first edge manifold channel and the second edge manifold channel are configured to connect to a pressure storage system.

2. The vehicular energy capture mat of claim 1, wherein the pressure storage system comprises: a bladder or diaphragm; wherein the bladder or diaphragm separates the tank into a fluid chamber and an air chamber; wherein the air chamber is configured to be pre-charged to a predetermined pressure level.

3. The vehicular energy capture mat of claim 2, wherein the predetermined pressure level is set based on expected vehicle types, with: a lower pressure setting for passenger vehicles; and a higher pressure setting for commercial vehicles.

4. The vehicular energy capture mat of claim 2, further comprising: a hydro turbine coupled to the pressure storage system; wherein stored pressurized fluid drives the hydro turbine; and wherein the hydro turbine drives a generator to produce electricity.

5. The vehicular energy capture mat of claim 4, wherein the pressure storage system is configured to: store fluid at high pressure from vehicle displacement; and release stored pressure gradually or rapidly to the hydro turbine based on power demand.

6. The vehicular energy capture mat of claim 1, wherein the fluid channels are formed directly within the molded body without separate hoses or tubes.

7. The vehicular energy capture mat of claim 1, wherein the molded body comprises: a wear-resistant upper surface for vehicle tire contact; flexible regions surrounding the fluid channels; and weather-resistant materials rated for temperatures from 0° F. to 120° F.

8. The vehicular energy capture mat of claim 1, wherein the pressure storage system is: built within the mat itself; or positioned outside of and adjacent to the mat.

9. The vehicular energy capture mat of claim 1, configured for installation in vehicle deceleration zones selected from: approaching stop signs; near pedestrian walkways; before traffic signals; on highway exit ramps; and on downward-sloped roadways.

10. The vehicular energy capture mat of claim 8, further comprising: an inverter connected to a generator; and electrical connections configured to direct generated power to at least one of: an electrical meter; a battery bank; or an electrical grid.

11. A vehicular kinetic energy capture and conversion system comprising:
a molded mat having a plurality of parallel fluid channels configured to displace fluid when compressed by vehicle tires;
a pressure storage system comprising: a bladder that separates pressurized air from fluid; wherein an air side is pre-charged to a baseline pressure; and wherein a fluid side receives fluid from the mat channels;
a manifold system comprising: fluid collection channels along mat edges;
fluid transfer lines connecting the mat to the pressure storage system; and fluid return pathways for system circulation;
an energy conversion assembly comprising: a hydro turbine driven by pressurized fluid from the storage system; a generator coupled to the hydro turbine; and an inverter connected to the generator output; and
a control system configured to: monitor pressure levels in the storage system; regulate fluid flow to the hydro turbine; and direct electrical output to at least one of a battery, meter, or grid.

12. The system of claim 11, wherein the pressure storage system is configured to maintain different baseline pressures for: distribution centers handling heavy trucks; retail locations with passenger vehicles; and mixed traffic areas with varying vehicle weights.

13. The system of claim 11, wherein the manifold system comprises: a primary fluid collection manifold on a first mat edge; a secondary fluid collection manifold on an opposite mat edge; and cross-connection channels between the manifolds for pressure balancing.

14. The system of claim 11, further comprising: multiple mats arranged in series or parallel; interconnecting fluid lines between adjacent mats; and a common pressure storage system serving the multiple mats.

15. The system of claim 11, wherein the control system is configured to: release stored pressure during peak electricity demand periods; maintain minimum pressure levels for system operation; and optimize energy generation based on traffic patterns.

16. The system of claim 11, wherein the energy conversion assembly is configured to: operate with variable fluid pressure inputs; maintain consistent electrical output; and shut down safely during low pressure conditions.

17. The system of claim 11, wherein the mat comprises: reinforced rubber compounds resistant to repeated compression; molded channel walls configured for millions of compression cycles; and wear-resistant surfaces for vehicle tire contact.

18. The system of claim 11, further comprising: pressure sensors throughout the fluid pathways; fluid level monitors in the storage system; and temperature sensors for system monitoring.

19. The system of claim 11, wherein the manifold system includes: an integrated fluid filter; a sediment collection point; and a maintenance access port.

20. The system of claim 11, wherein the system is configured to: capture energy from decelerating vehicles; store energy as pressurized fluid; and release stored energy during periods of high electrical demand.
